(19) United States
(12) Patent Application Publication
(10) Pub. No.: US 2016/0371871 A1
(43) Pub. Date: Dec. 22, 2016

(54) DEFINING AN ANIMATION OF A VIRTUAL OBJECT WITHIN A VIRTUAL WORLD

(71) Applicant: NATURALMOTION LIMITED, Oxfordshire (GB)

(72) Inventor: Alberto Aguado, Aston, Oxforshire (GB)

(73) Assignee: Naturalmotion Limited, Oxfordshire (GB)

(21) Appl. No.: 15/121,343

(22) PCT Filed: Feb. 25, 2015
(86) PCT No.: PCT/GB2015/050542

§ 371 Date: Aug. 24, 2016

(30) Foreign Application Priority Data
Feb. 27, 2014 (GB) 1403427.6

(51) Int. Cl. G06T 13/40

(52) U.S. Cl. CPC G06T 13/40; G06F 3/04847

(57) ABSTRACT

A system, a machine-readable storage medium storing instructions, and a computer-implemented method are described herein to define an animation of a virtual object within a virtual world. The animation comprises performing, at each of a series of time points, an update that updates values for object attributes of the virtual object. A user is allowed to define the animation by specifying a structure representing the animation. The structure comprises a plurality of items and one or more connections between respective items. Each item represents a respective operation that may be performed when performing the update. A connection between two items represents that respective output data generated by the operation represented by a first one of the two items is input to the operation represented by the other of the two items.

### FIELD OF THE INVENTION

The present invention relates to a method of defining an animation of a virtual object within a virtual world, a method of animating a virtual object within a virtual world, and apparatus and computer programs for carrying out such methods.

### BACKGROUND OF THE INVENTION

There are many known ways to author an animation of a virtual object within a virtual world. One example is the graph-based approach in which the animation of an object is depicted as a user-defined graph of interconnected nodes, with each node representing a particular computational process involved in the animation, the ordering and dependencies of the nodes as represented by the graph representing the ordering and dependencies of the various computational processes.

US2010/0134501, the entire disclosure of which is incorporated herein by reference, discloses an example of such a graph-based approach. In particular, it discloses a method of defining an animation of a virtual object within a virtual world, wherein the animation comprises performing at each of a series of time points, an update that updates values for object attributes of the virtual object.

### SUMMARY OF THE INVENTION

It is desirable to provide a flexible means for defining an animation, whilst ensuring that execution or evaluation of the animation can be performed efficiently (e.g. reducing processing requirements). Often, these two aims of achieving efficiency and flexibility are incompatible with one another. However, the present invention aims to address both of these issues.

According to an first aspect of the invention, there is provided a method of defining an animation of a virtual object within a virtual world, wherein the animation comprises performing, at each of a series of time points, an update that updates values for object attributes of the virtual object, the method comprising: allowing a user to define the animation by specifying, on a user interface, a structure representing the animation, wherein the structure comprises a plurality of items and one or more connections between respective items, wherein each item represents a respective operation that may be performed when performing the update, wherein a connection between two items represents that respective output data generated by the operation represented by a first one of the two items is input to the operation represented by the other of the two items, and wherein for at least one of the one or more connections the respective data comprises effector data, the effector data representing one or more effectors for the virtual object.

In some embodiments, said allowing comprises allowing the user to specify that the structure comprises an item for which the respective operation comprises creating at least one effector for the virtual object and for which the output data generated by the respective operation comprises effector data representing the at least one created effector.

In some embodiments, said allowing comprises allowing the user to specify that the structure comprises a particular item for which: (a) the input to the respective operation for said particular item comprises effector data representing one or more effectors for the virtual object; and (b) the respective operation for said particular item generates output data based, at least in part, on at least one effector represented by the effector data of the input to the respective operation for said particular item.

The respective output data generated by the respective operation for said particular item may comprise effector data representing one or more effectors for the virtual object.

Said allowing may comprise allowing the user to specify that the effector data of the respective output data generated by the respective operation for said particular item forms at least part of the respective data of the input to two or more other items of said structure.

The respective operation for said particular item may comprise modifying at least one effector that is represented by the effector data of the input to said respective operation for said particular item.

The respective operation for said particular item may comprise combining two or more effectors that are represented by the effector data of the input to said respective operation for said particular item.

The respective operation for said particular item may comprise cancelling at least one effector that is represented by the effector data of the input to said respective operation for said particular item.

The respective operation for said particular item may comprise performing inverse kinematics processing or inverse dynamics processing for the virtual object based on at least one effector that is represented by the effector data of the input to the respective operation for said particular item.

In some embodiments, said allowing comprises allowing the user to specify that the effector data of the input to the respective operation for said particular item comprises first effector data of the respective output data generated by the respective operation of a first item of said structure and second effector data of the respective output data generated by the respective operation of a second item of said structure.

According to a second aspect of the invention, there is provided a method of animating a virtual object within a virtual world, wherein the animation comprises performing, at each of a series of time points, an update that updates values for object attributes of the virtual object, the method comprising performing processing based on a user-defined structure representing the animation, the user-defined structure comprising a plurality of items and one or more connections between respective items, wherein each item represents a respective operation that may be performed when performing the update, wherein a connection between two items represents that respective output data generated by the operation represented by a first one of the two items is input to the operation represented by the other of the two items, wherein for at least one of the one or more connections the respective data comprises effector data, the effector data representing one or more effectors for the virtual object.

In some embodiments, the structure comprises an item for which the respective operation comprises creating at least one effector for the virtual object and for which the output data generated by the respective operation comprises effector data representing the at least one created effector.

In some embodiments, the structure comprises a particular item for which: (a) the input to the respective operation for said particular item comprises effector data representing one or more effectors for the virtual object; and (b) the respective operation for said particular item generates output data based, at least in part, on at least one effector represented by the effector data of the input to the respective operation for said particular item.

The respective output data generated by the respective operation for said particular item may comprise effector data representing one or more effectors for the virtual object.

The effector data of the respective output data generated by the respective operation for said particular item may form at least part of the respective data of the input to two or more other items of said structure.

The respective operation for said particular item may comprise modifying at least one effector that is represented by the effector data of the input to said respective operation for said particular item.

The respective operation for said particular item may comprise combining two or more effectors that are represented by the effector data of the input to said respective operation for said particular item.

The respective operation for said particular item may comprise cancelling at least one effector that is represented by the effector data of the input to said respective operation for said particular item.

The respective operation for said particular item may comprise performing inverse kinematics processing or inverse dynamics processing for the virtual object based on at least one effector that is represented by the effector data of the input to the respective operation for said particular item.

In some embodiments, the effector data of the input to the respective operation for said particular item comprises first effector data of the respective output data generated by the respective operation of a first item of said structure and second effector data of the respective output data generated by the respective operation of a second item of said structure.

In some embodiments of the first and second aspects, each of said one or more effectors for the virtual object comprises, respectively, one or more of: a target for at least part of said virtual object; and a constraint for at least part of said virtual object.

In some embodiments of the first and second aspects, the structure is a graph. The graph may be a directed acyclic graph.

According to a third aspect of the invention, there is provided an apparatus arranged to carry out any one of the above-mentioned methods.

According to a fourth aspect of the invention, there is provided a computer program which, when executed by a processor, causes the processor to carry out any one of the above-mentioned methods. The computer program may be stored on a computer-readable medium.

### BRIEF DESCRIPTION OF THE DRAWINGS

Embodiments of the invention will now be described, by way of example only, with reference to the accompanying drawings, in which:

FIG. 1 schematically illustrates an example computer system according to an embodiment of the invention;

FIG. 2 schematically illustrates three example virtual objects within a virtual world;

FIG. 3 schematically illustrates an object in an animation according to an embodiment of the invention;

FIG. 4 schematically illustrates a compound object representing a person on a skateboard;

FIG. 5 schematically illustrates regions, represented by physics data, for the joints for the object of FIG. 3;

FIG. 6 schematically illustrates an example user interface 600 according to an embodiment of the invention;

FIG. 7 illustrates an example graph that may be constructed using the user interface of FIG. 6;

FIG. 8 illustrates an example of a graph that has a so-called “cyclic dependency”;

FIG. 9 illustrates how multiple data values, which are always passed together between a source node and a target node, may be illustrated as a single compound data value using the user interface of FIG. 6;

FIG. 10 illustrates a node type called a grouper node which the user interface of FIG. 6 may provide to allow the user to manage compound attributes;

FIG. 11 illustrates the passage of compound attributes between nodes, in the user interface of FIG. 6;

FIG. 12 illustrates the use and operation of a container node in the user interface of FIG. 6;

FIG. 13 illustrates the sub-graph for the container node of FIG. 12;

FIG. 14 illustrates the sub-graph of a container representing an example state machine in the user interface of FIG. 6;

FIG. 15 illustrates an example transition for a state machine;

FIG. 16 illustrates the use of a transition node in the transition of FIG. 15;

FIG. 17 illustrates another example transition for a state machine;

FIG. 18 illustrates the use of a transition node in the transition of FIG. 17;

FIG. 19 illustrates the use of functional connections in the user interface of FIG. 6;

FIG. 20 illustrates how the graph of FIG. 19 might look after its functional inputs and outputs are expanded to expose their underlying components;

FIG. 21 illustrates the actual directed acyclic graph for the graphs of FIGS. 19 and 20;

FIG. 22 illustrates an example two-level blend tree;

FIG. 23 illustrates the directed acyclic graph corresponding to the graph of FIG. 22;

FIG. 24 illustrates an example hierarchical representation of a graph for an update process for an animation;

FIG. 25 illustrates an example graph making use of pass-down pins in the user interface of FIG. 6;

FIG. 26 schematically illustrates a method for performance by a processor in executing the user interface of FIG. 6 to apply the rules in accordance with an embodiment of the invention;

FIG. 27 schematically illustrates some of the data that may be stored in embodiments of the invention.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### 1) System Overview

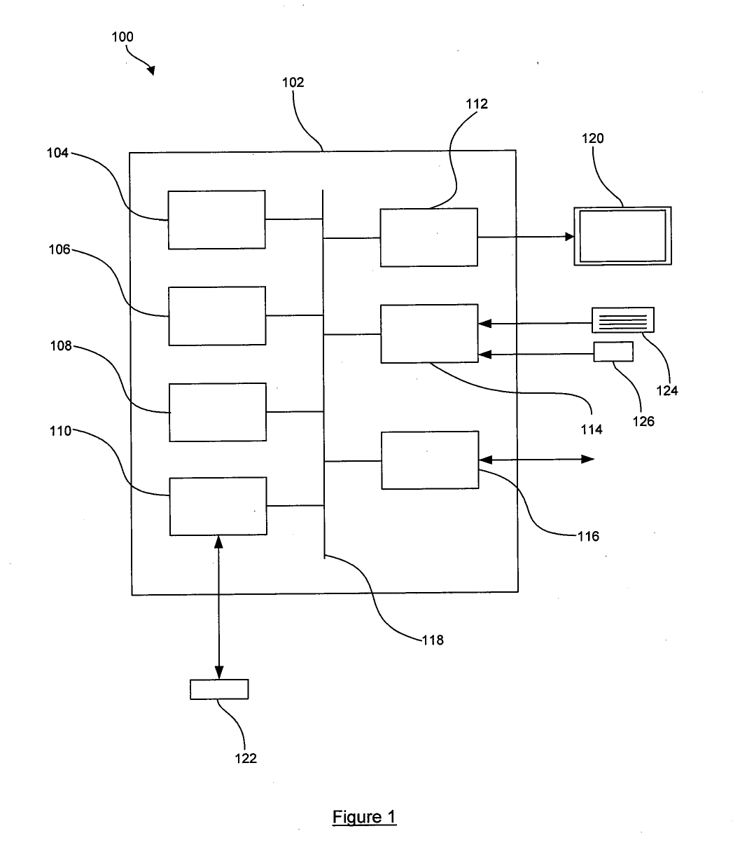

Embodiments of the invention may be executed by a computer system. FIG. 1 schematically illustrates an example computer system 100 according to an embodiment of the invention. The system 100 comprises a computer 102. The computer 102 comprises: a storage medium 104, a memory 106, a processor 108, a storage medium interface 110, a user output interface 112, a user input interface 114 and a network interface 116, which are all linked together over one or more communication buses 118.

The storage medium 104 may be any form of non-volatile data storage device such as one or more of a hard disk drive, a magnetic disc, an optical disc, a ROM, etc. The storage medium 104 may store an operating system for the processor 108 to execute in order for the computer 102 to function. The storage medium 104 may also store one or more computer programs (or software or instructions or code) that form part of an embodiment of the invention.

The memory 106 may be any random access memory (storage unit or volatile storage medium) suitable for storing data and/or computer programs (or software or instructions or code) that form part of an embodiment of the invention.

The processor 108 may be any data processing unit suitable for executing one or more computer programs (such as those stored on the storage medium 104 and/or in the memory 106) which have instructions that, when executed by the processor 108, cause the processor 108 to carry out a method according to an embodiment of the invention and configure the system 100 to be a system according to an embodiment of the invention. The processor 108 may comprise a single data processing unit or multiple data processing units operating in parallel or in cooperation with each other. The processor 108, in carrying out data processing operations for embodiments of the invention, may store data to and/or read data from the storage medium 104 and/or the memory 106.

The storage medium interface 110 may be any unit for providing an interface to a data storage device 122 external to, or removable from, the computer 102. The data storage device 122 may be, for example, one or more of an optical disc, a magnetic disc, a solid-state-storage device, etc. The storage medium interface 110 may therefore read data from, or write data to, the data storage device 122 in accordance with one or more commands that it receives from the processor 108.

The user input interface 114 is arranged to receive input from a user, or operator, of the system 100. The user may provide this input via one or more input devices of the system 100, such as a mouse (or other pointing device) 126 and/or a keyboard 124, that are connected to, or in communication with, the user input interface 114. However, it will be appreciated that the user may provide input to the computer 102 via one or more additional or alternative input devices. The computer 102 may store the input received from the input devices via the user input interface 114 in the memory 106 for the processor 108 to subsequently access and process, or may pass it straight to the processor 108, so that the processor 108 can respond to the user input accordingly.

The user output interface 112 is arranged to provide a graphical/visual output to a user, or operator, of the system 100. As such, the processor 108 may be arranged to instruct the user output interface 112 to form an image/video signal representing a desired graphical output, and to provide this signal to a monitor (or screen or display unit) 120 of the system 100 that is connected to the user output interface 112.

Finally, the network interface 116 provides functionality for the computer 102 to download data from and/or upload data to one or more data communication networks (such as the Internet or a local area network).

It will be appreciated that the architecture of the system 100 illustrated in FIG. 1 and described above is merely exemplary and that other computer systems 100 with different architectures and additional and/or alternative components may be used in embodiments of the invention.

### 2) Animations—Overview

In one embodiment of the invention, a user uses the system 100 to define or create one or more animations (as an animation design tool or animation editor). In another embodiment of the invention, the system 100 may be used to perform or process and output the one or more animations that have been defined. The same system 100 or different systems 100 may be used for the animation creation processing and the animation performance processing. This is described in more detail below.

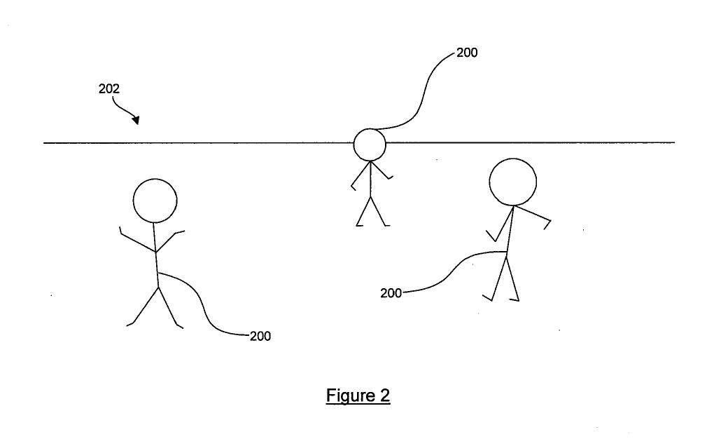

Embodiments of the invention are concerned with animations and, in particular, how to define an animation of a virtual object (or a character) that is located (or resides) within a virtual world (or environment). FIG. 2 schematically illustrates three example virtual objects 200 within a virtual world 202. The virtual objects 200 shown in FIG. 2 (and the rest of this application) represent human beings, but it will be appreciated that embodiments of the invention are equally applicable to animations of virtual objects that represent other articles, items, animals, etc. and other types, structures and forms of object that have different intended representations. The virtual world 202 may be any virtual environment, arena or space containing the virtual objects 200 and in which the virtual objects 200 may be moved or animated. Thus, the virtual world 202 may represent a real-world location, a fictitious location, a building, the outdoors, underwater, in the sky, a scenario/location in a game or in a movie, etc.

Each virtual object 200 has various associated object attributes, such as the position (i.e. location and orientation) of various parts of the object 200 within the virtual world 202. For example, for an object 200 representing a human being, the attributes may include: the overall position and orientation of the object 200 within the virtual world 202; the position and orientation of limb parts; the position and orientation of hands, feet, the head, etc.

An animation source for (or associated with) an object 200 is a collection of data from which values for the various object attributes can be derived at each time-point in a series (or sequence) of time-points. These time-points may correspond to video frames, video fields, or any other time or display frequency of interest. The animation source may explicitly store, for each time-point, the values for the object attributes. Alternatively, the animation source may store, for one time-point, the difference between the value for an object attribute at that time point and the value for that object attribute at a preceding time point (i.e. using differential encoding). Other ways of storing/encoding the data for the animation source are possible. Consequently, the animation source represents how the object 200 moves from time-point to time-point in the sequence of time-points. For ease of explanation, the rest of this description shall refer to frames (and a sequence of frames) as an example of time-points (and the sequence of time-points for the animation). However, the skilled person will appreciate that embodiments of the invention relate to time-points in general and not just video frames (or video images).

Examples of animation sources include, for example, data representing a person running, data representing a person walking, data representing a person jumping, etc., where these various sets of data may be used to set the attributes of the object 200 so that the object 200 (when displayed on the monitor 120) appears to be performing the respective animation/movement (e.g. running, walking, jumping, etc.).

Different object types may have different sets of one or more animation sources—for example, an object 200 representing a dog will have a different “physical” structure from that of an object 200 representing a human, and therefore separate distinct animation sources will be associated with the different dog and human objects 200.

An animation source may be stored, for example, on the storage medium 104. The storage medium 104 may store a database comprising one or more animation sources for one or more types of object 200. Additionally or alternatively, the data for one or more animation sources may be stored in the memory 106 or in the data storage device 122, or may be accessible to the computer 102 from a location accessible via the network interface 116.

An animation for the object 200 then comprises performing, at each time point in a series of time points, an update process that updates values for the object attributes of that object 200. This update process could involve simply determining values from an animation source for the object 200 in order to update (or set) the corresponding object attributes with those values accordingly. However, as described in more detail later, this update process could involve determining values from one or more animations sources for the object 200 and performing one or more data processing steps/procedures/functions on those values in order to obtain a final set of values with which to then update (or set) the corresponding object attributes accordingly. For example, a “running” animation source for an object 200 and a “walking” animation source for that object 200 could be blended together to form a “jogging” animation for that object 200, with that “jogging” animation then being blended with a “limp” animation to produce a “limping-jog” animation for the object 200. This processing could be dependent on a variety of factors—for example, when an animation is being performed and output as part of a computer game, the animation may switch between a “running” animation and a “walking” animation for an object 200 in dependence upon an input from a user received during the game play.

In the embodiments described below, the animations relate to so-called “skeletal animation”, but it will be appreciated that different types or styles of animation fall within the scope of the present invention. The object attributes for an object 200 may be represented by some or all of the following data (depending on the type of animation and how the object 200 and its attributes are to be represented): (a) topological data; (b) geometric data; (c) physical data; (d) trajectory data; (e) skinning data; and (f) rendering data. These data are described in more detail below. It will be appreciated that the object 200 may have attributes in addition to, or as alternatives to, the attributes as described below with reference to the various data (a)-(f). The geometric data and the trajectory data may be collectively referred to as transform data.

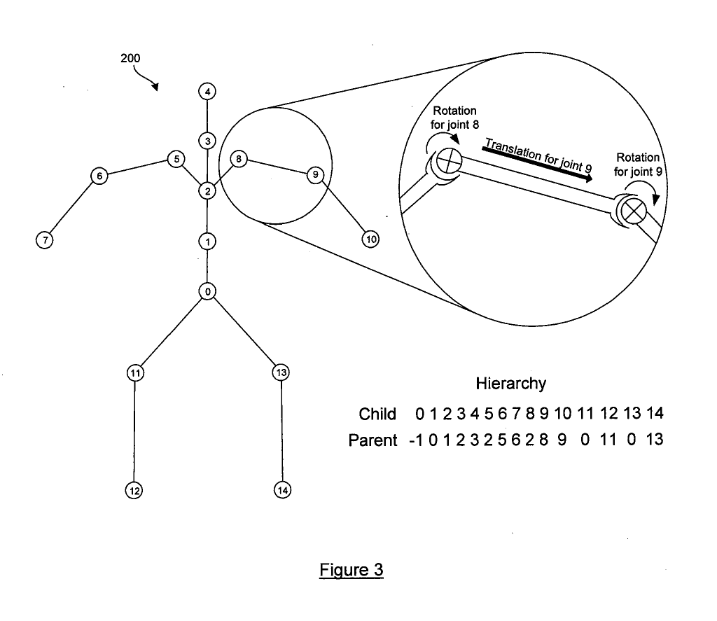

FIG. 3 schematically illustrates an object 200 in an animation according to an embodiment of the invention. The object 200 comprises a plurality of object sections (or “bones”) linked together by respective joints. In FIG. 3, the sections of the object 200 are the straight lines whilst the joints of the object 200 are the numbered circles.

In general, a joint is a (simulated) point of contact between two or more object sections so that that joint links (or creates an association between) those sections. In other words, such a joint forms a simulated connection or tie between object sections (in the same way that, for example, a forearm is connected to an upper arm by virtue of an elbow joint). In this way, an object section may have one or more joints associated with it. A joint normally occurs at an end of the object section(s) it is associated with.

Some joints (such as joint 10 in FIG. 3) occur at the end of an object section, but do not link that section to another section. These joints merely serve to indicate the location of the free (i.e. unconnected) end of that section.

In some embodiments, each object section is “rigid” in that the distance between the joints associated with that section is constant, although, of course, each rigid section may have its own length/distance which may be different from the length/distance for the other rigid sections. However, it will be appreciated that in other embodiments one or more of the sections of the object 200 may not be “rigid”.

The object 200 may therefore be considered to comprise a plurality of object parts. In some embodiments, the topological data represents the object 200 as a plurality of joints (i.e. the object parts are just the joints). In some embodiments, the topological data represents the object 200 as a plurality of object sections (i.e. the object parts are just the bones). In some embodiments, the topological data represents the object 200 as a plurality of joints together with a plurality of object sections. The actual representation does not matter for embodiments of the invention and therefore in this description the topological data shall represent the object 200 as a plurality of joints. However, the skilled person will appreciate that the following description may be applied analogously to the alternative styles of representation.

The object parts may be considered as forming a skeleton, or framework, for the object 200.

The object parts (joints in this representation) are linked together, or are associated with each other, in a hierarchy. The hierarchy of joints illustrated in FIG. 3 may be represented by table 1 below:

TABLE 1

| | Joint ID | | | | | | | | | | | | | | |
|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 |
| Parent ID | −1 | 0 | 1 | 2 | 3 | 2 | 5 | 6 | 2 | 8 | 9 | 0 | 11 | 0 | 13 |

In this hierarchy of joints for the object 200, each joint, other than a central, basis root joint (labelled with a joint ID of 0) is a child of another joint in the hierarchy, i.e. every joint other than that root joint is associated with (or linked to) a second joint in the hierarchy (by virtue of a connecting object section), where that second joint is considered to be the parent of that joint. The fact that the central joint is not a child of another joint (and therefore has no parent joint) is represented in table 1 by indicating a parent ID of −1. For example, joint 2 is a child of joint 1 and itself has three children, namely joints 3, 5 and 8. As another example, joint 10 is a child of joint 9, but has no children itself. A joint such as joint 10 that has no child joints (i.e. a joint that is not itself a parent) is included so as to represent a “terminating end” of a section of the object 200, i.e. to indicate the location of the extremities of the object 200. Due to the connecting nature of the object sections that link joints, the movement, position and orientation of a joint in the virtual world 202 is affected by the movement, position and orientation of the parent of that joint in the virtual world 202.

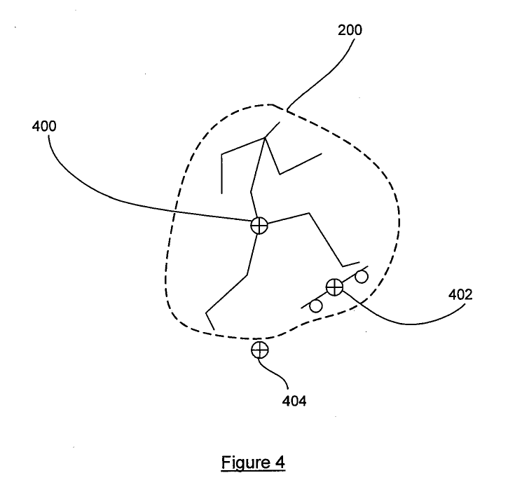

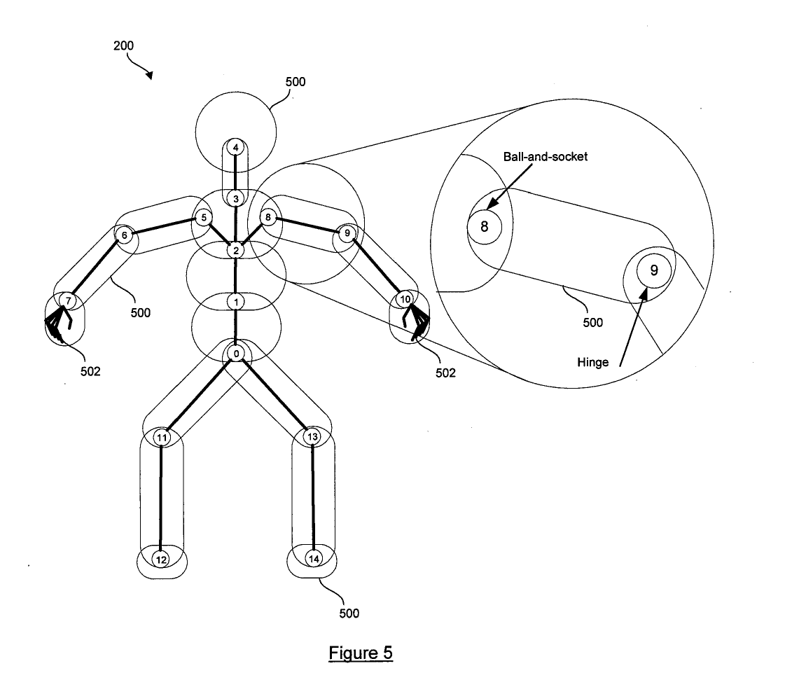

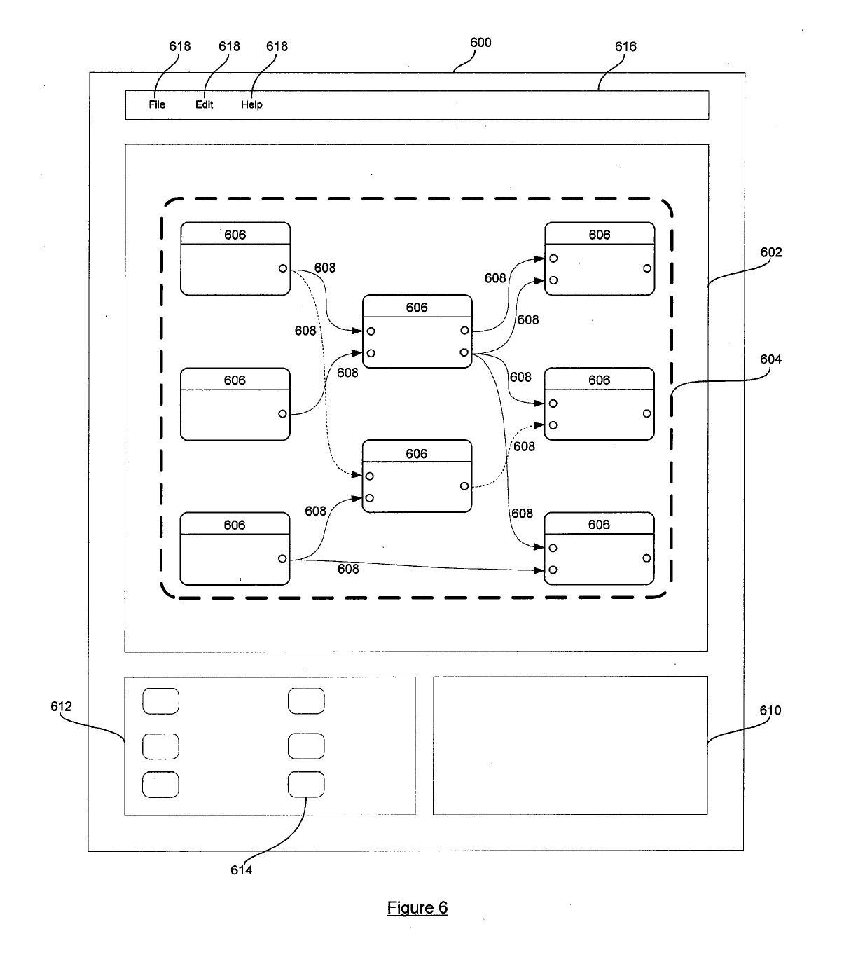

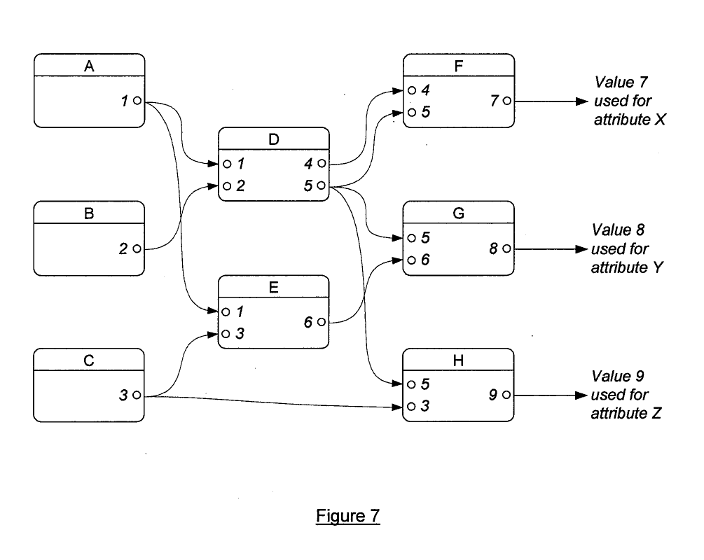

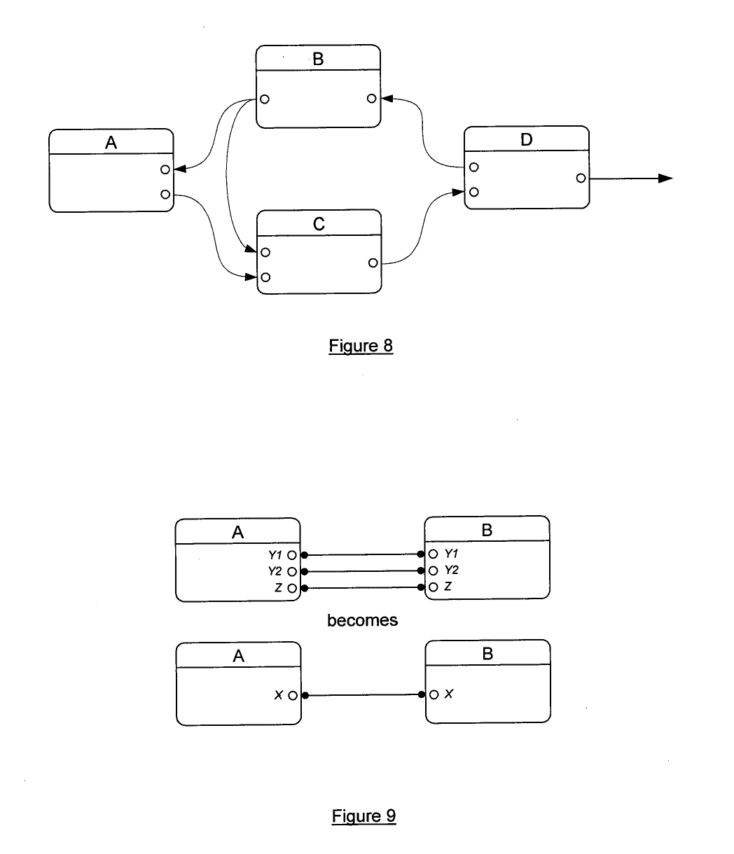

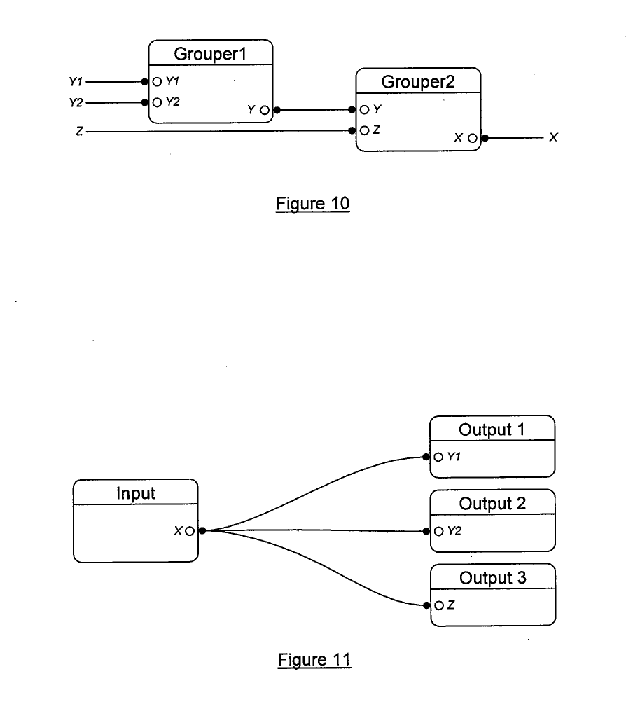

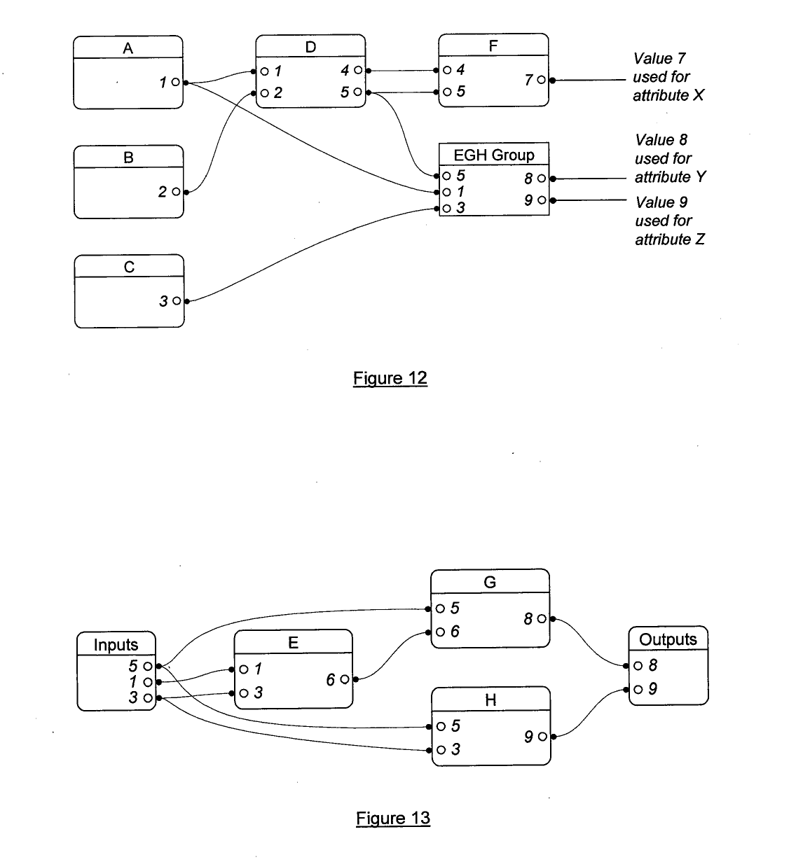

An object may have multiple root joints. For example, FIG. 4 schematically illustrates a compound object 200 representing a person on a skateboard. This may be considered one object as the person and the skateboard may be considered to be one set of semantically linked data (i.e. a single character). However, as the person and the skateboard are not rigidly or permanently attached to each other, they each have their own root joints, namely a root joint 400 for the person and a root joint 402 for the skateboard. The joints for the person will then be hierarchically related to the root joint 400, whilst the joints for the skateboard will be hierarchically related to the root joint 402.

The topological data for the object 200 is data that represents this hierarchy (or hierarchies) or structure of the object parts, i.e. data defining the parent-child relationships between the various object parts that make up the object 200. For example, the topological data for the object 200 may be stored in the form of table 1 above.

The geometric data for the object 200 represents the relative positions and orientations of the object parts. The values given to the geometric data represent the positioning of the object 200 in a particular posture. In effect, the attributes for the object 200 represented by the geometric data are the length of each object section (bone) together with that bone's orientation relative to its parent bone, i.e. this geometric data represents the distance between a joint and its parent joint, together with the orientation of that joint relative to the parent joint. There are many well-known ways of representing this geometric data, such as: (a) using respective transformation matrices for the joints; (b) using respective pairs of 3×3 rotation matrices and 1×3 translation matrices; or (c) using respective quaternions. As these methods are well-known, and as the particular method used is not important for embodiments of the invention, these methods shall not be described in more detail herein. An example representing some of the geometric data for joints 8 and 9 is shown in FIG. 3.

The geometric data for a particular joint is normally defined in a coordinate space local to the parent of that joint (i.e. in which that parent is fixed). Thus, for example, if a “shoulder joint” 8 of FIG. 3 moves but the “elbow joint” 9 of FIG. 3 does not move relative to the shoulder joint, then the geometric data 308 for the elbow joint would not change.

The attribute of the object 200 represented by the trajectory data is the location and orientation in the virtual world 202 of a so-called “trajectory joint” 404 for the object 200. The trajectory joint 404 is used as a representative location of the object 200 within the world 202. Thus, different values for the trajectory data place the trajectory joint 404 (and hence the object 200) at different locations in the virtual world 202.

The trajectory joint 404 is usually not an actual joint of the object 200 (i.e. it need not a form part of the structure of the object 200), but is simply a position and orientation within the world 202 to represent the overall location and orientation for the object 200. For convenience, the trajectory joint 404 may be represented as a “special” joint within the hierarchy represented by the topological data. The trajectory joint 404 need not be a root joint (with no parent) but can be located anywhere within the skeleton topology as represented by the topological data. However, for its uses as will be described below it is the location and orientation of the joints of the object 200 (as specified by virtue of the topological data and the geometric data) relative to the trajectory joint 404 that is important and that results in a particular joint or object section being at a particular/absolute position and orientation within the entire virtual world 202. One way of viewing or implementing this is for all joints of the object 200 (as specified by the topological data), including root joints, to be ultimately parented to the trajectory joint 404 so that their location and orientation within the virtual world 202 can be calculated based on the trajectory data, the topological data and the geometric data.

The trajectory joint 404 has two main uses for animation processing:
The trajectory joint 404 may be used when animations are to be concatenated, where the object 200 is moving away from some origin in the world 202. For example, for a concatenation of a first animation of the object 200 running and a second animation of the object 200 jumping, the object 200 should not be returned to a starting position within the virtual world 202 at the transition between the first and the second animations. By lining up the trajectory joint 404 of the second animation with that of the first animation at the point of transition the motion for the object 200 is continuous. This is also applicable to cyclical animations, where the second animation is the same as the first animation (such as a walk cycle in which a walk animation is simply repeated).
The trajectory joint 404 may be used for blending animations together. For example, when blending an animation of the object 200 turning to the left with an animation of the object 200 running to the right, then if these animations were simply blended together without moving them into a common frame of reference, then they would partially cancel out each other's movements. Consequently, when performing a blend between two or more animations for the object 200, the blending processing is performed as if the two animations share a common trajectory joint 404.

The orientation of a trajectory joint 404 is just as important as its position, as it represents the overall direction that the object 200 is facing.

The trajectory data may be represented as a delta transform attribute for the object 200, this attribute representing the motion of the trajectory joint 404 from a preceding time-point to a current time point.

The physical data represents various physical attributes for the object 200. These physical attributes represent or impose various physical properties or restrictions or limitations on the object 200. Typically, subsets of the physical data are associated with respective joints represented by the topological data. For example, one or more of the joints represented by the topological data may have corresponding physical data representing attributes such as:
Size and shape of a region around that joint. The region may be a capsule or a cylinder, with the size and shape being defined by lengths and radii accordingly. The region may represent the body, or the “bulk”, of the object 200 that is supported by the framework of bones and joints. If another object 200 were to enter this region, then the two objects 200 may be considered to have collided. FIG. 5 schematically illustrates such regions 500 for the joints for the object 200.
A mass for the joint.
An inertia property for the joint.
Other properties of the joint such as strength, damping factors, type of joint. For example, the “shoulder” joint 8 in FIG. 5 may be a ball-and-socket joint whilst the “elbow” joint 9 in FIG. 5 may be a hinge joint. Such data may therefore restrict how one joint may move (e.g. hinge or rotate or pivot) with respect to another joint (a parent or a child joint).

However, as shown in FIG. 5, some of the joints 502 represented by the topological data may not have corresponding physical attributes.

The skinning data is data that enables so-called “skinning” for the animation. The process of skinning takes a definition of the surface of the object 200 and attaches it to the skeleton formed by the object parts (the joints and/or bones). The skinning data is therefore data defining this object surface, which is an attribute of the object 200.

The rendering data is data that enables so-called “rendering” of the animation. The process of rendering actually outputs or displays the skinned surface with relevant textures, colours, lighting, etc. as appropriate. The rendering data is therefore data defining the textures, colours, lighting, etc., which are attributes of the object 200.

### 3) Effectors

“Effectors” are well-known in this field of technology, but as embodiments of the invention relate to the use of effectors, they shall be described in more detail below. However, it will be appreciated that the skilled person would be aware of effectors and any known aspects of effectors that are not set out below.

An “effector” is a constraint or target or goal to be achieved which is related to (or associated with, or defined/specified for) a corresponding joint of the object 200. “Effector data” is then data which represents one or more effectors for (or which are to be applied to) the object 200, or at least a part of the object 200.

An effector for a joint may represent a desired position and/or orientation for (or associated with) that joint of the object 200. As such, an effector could be considered to be a target or goal to be achieved by the animation of the object 200. Examples include:
In the animation of the compound object 200 representing a person on a skateboard illustrated in FIG. 4, effectors might be specified for joints in the feet of the person which constrain the joints in the feet of the person so that, during the animation, the soles of the feet of the person should remain coincident with and parallel to the upper surface of the skateboard in order to represent “basic” skateboarding.
In the animation of an object 200 representing a person moving (e.g. walking) through the virtual world 202, an effector might be specified for a neck joint and/or a head joint of the person which constrains the orientation of the neck and/or head joints so that the head faces in a particular direction, i.e. so that, during the animation, the person appears to be looking at a fixed point within the virtual world 202.
In the animation of an object 200 representing a person, an effector may be specified for a hand joint of the person, where the effector specifies that, during the animation, the hand should be moved to a particular location within the virtual world 202 (e.g. to move towards a simulated button in the virtual world 202 so as to then press that button).
In the animation of an object 200 representing a person, an effector may be specified for a hand joint of the person, where the effector specifies that, during the animation, the hand should point towards another object in the virtual world 202, which may be a moving object (so as to “track” that moving object).

It will be appreciated there are many other types of effector that might be specified for an animation and that the above are provided merely as examples to help demonstrate the notion of an effector.

It is possible that a joint of the object 200 may have no effectors specified. It is possible that a joint of the object 200 may have a single effector specified. It is also possible that a joint for an object 200 may have a plurality of effectors specified.

It is possible that two or more effectors (either for the same joint or for different joints) may conflict with each other. For example, the “left elbow” joint of a person object 200 may have an effector which specifies that the left elbow should move a first distance to the left in the virtual world 202, whilst the “right elbow” joint of the person object 200 may have an effector which specifies that the right elbow should move a second distance to the right in the virtual world 202, and it is possible that, given the physical data for the object 200, it is not possible to move the left elbow the first distance to the left whilst moving the right elbow the second distance to the right. As another example, at a particular point during a computer game, a hand joint of a game character in the computer game may have a first effector specifying that the right hand joint should point in a particular direction (e.g. to aim a gun at a target) and a second effector specifying that the right hand joint should move to the left shoulder (e.g. because the character has just been shot in the left shoulder and wishes to grasp the wound). To assist with such conflicts, in some embodiments, a weighting may be associated with each effector which indicates the relative importance of that effector to achieving an animation goal. With the first example above, the effector to move the left elbow might have a weight of 0.2 and the effector to move the right elbow might have a weight of 0.8, so that the person object 200 will move to the right, but not quite so much as if the effector for the left elbow had not been specified. With the second example above, the second effector to move the right hand joint to the left shoulder might be arranged to override the first effector to point the right hand in a particular direction (as grasping a wound might be viewed as more critical than aiming a weapon).

It will be appreciated that effectors (and therefore effector data) may be generated dynamically, for example: depending on events that occur during a computer game or animation simulation, or based on commands that are issued by a user (e.g. when a player of a game presses one or more buttons on a game controller to instruct a game character to perform an action).

Given a set of one or more effectors, it is possible to use inverse kinematics (IK) to derive (or calculate or determine), for one or more joints of the object 200, a corresponding joint angle, so that, when those joint angles are applied to their respective joints, the object 200 will satisfy (or at least try to satisfy) those effectors. Inverse kinematics is well-known in this field of technology and shall not be described in detail herein. It will be appreciated that a set of effectors may be defined for which no solution can be obtained, such as when they are conflicting effectors which cannot both be satisfied—in this case, the inverse kinematics processing performed may use the above-mentioned weightings for the effectors to help resolve the effectors (e.g. derive joint angles so as to satisfy one effector and not another effector). Similarly, for a given set of effectors there may be multiple different solutions which satisfy all of the effectors. For example, an effector for a right hand joint may be specified to move the right hand joint to a particular location in the virtual world 202 and an effector for a right shoulder joint may be specified to move the right shoulder joint to a particular location in the virtual world 202—both effectors can be satisfied whilst having the right elbow joint in different places.

There are many well-known numerical methods for solving inverse kinematics to obtain a set of joint angles which satisfy a set of effectors. Examples of such numerical methods include: cyclic coordinate descendent; step descendent optimization; Jacobian or pseudo-inverse methods; and Lagrange multipliers. It will be appreciated that any method of solving inverse kinematics may be used, including those examples listed. The solution of inverse kinematics is generally considered to be relatively computationally expensive. It is therefore desirable to minimise both the frequency and the size (i.e. number of effectors being solved for) of performing inverse kinematics computations.

Another animation technique is known as inverse dynamics. With inverse dynamics, a set of one or more effectors may be specified and, instead of explicitly calculating joint angles (as in inverse kinematics), one or more virtual forces and/or one or more virtual torques are applied to the object 200 and its object parts, where the one or more virtual forces and/or one or more virtual torques are calculated or determined so their application to the object 200 tries to satisfy the set of effectors. The inverse dynamics processing is carried out by a physics engine that simulates a set of laws of physics (e.g. real life Newtonian laws of physics or imaginary laws of physics in a simulated universe). Again, inverse dynamics is well-known in this field of technology and shall not be described in detail herein. Inverse dynamics processing is relatively computationally expensive. It is therefore desirable to minimise both the frequency and the size (i.e. number of effectors being solved for) of performing inverse dynamics computations.

### 4) Data Storage

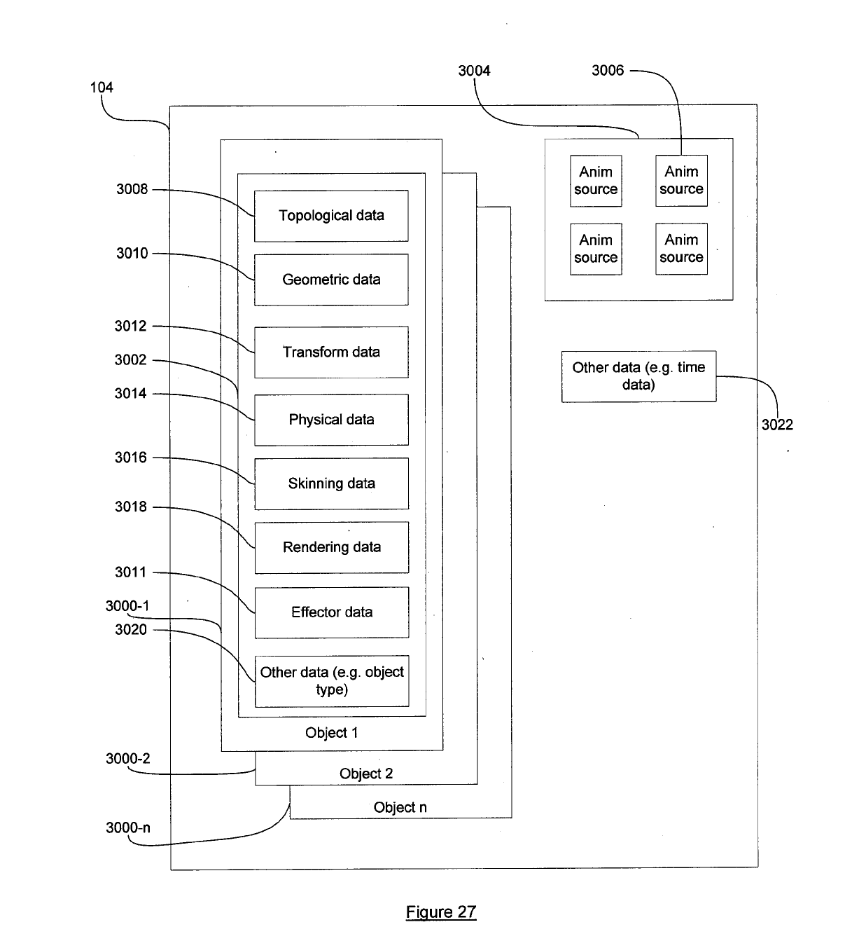

FIG. 27 schematically illustrates some of the data that may be stored in the storage medium 104 (or additionally or alternatively stored in the memory 106 or the data storage device 122, or which may be accessible via the network interface 116). There may be a set or database 3004 of one or more animation sources 3006. Each animation source 3006 will be applicable to a particular object type and a particular action type (e.g. walking, running and jumping animation sources for human objects 200, and walking, running and jumping animation sources for cat objects 200). There may be respective data 3000 for one or more objects 200—in FIG. 27, there are n objects 200, each with their own data 3000-1, 3000-2, . . . , 3000-n. The data 3000 for an object 200 may include a set 3002 of attribute data for that object 200, including one or more of: topological data 3008; geometric data 3010; effector data 3011; trajectory data 3012; physical data 3014; skinning data 3016; rendering data 3018; and other data 3020 specific to that object (e.g. a type of the object 200, so that appropriate animation sources 3006 may be used accordingly for that object 200). There may also be stored other data 3022 (such as timing data) which is not specific to any one particular object 200.

As mentioned above, the animation of a virtual object 200 within a virtual world 202 comprises performing, at each frame of a series of frames (or other time points), an update that updates values for (or assigned to) the object attributes for that virtual object 200. In other words, at each frame during an animation of an object 200, an update process (or procedure) is carried out that updates (i.e. sets) the object attributes for the object 200 according to values that the update process determines for those attributes. This can include, for example, determining a set of one or more effectors an object 200 (thereby setting effector data 3011 for that object 200), and performing inverse kinematics and/or inverse dynamics and/or other processing based on the effectors. Each virtual object 200 within the virtual world 202 undergoes its own update process for each frame.

### 5) Animation Graphs

Embodiments of the invention provide methods and systems for allowing a user to describe or define the update process for a virtual object 200. In particular, embodiments of the invention allow a user to define the update by specifying, on a user interface, an animation structure (or graph or network) representing the update process for a virtual object 200. This is described in more detail below. Different virtual objects 200 may have their own respective animation structures defined for them, and the animation editor provided by embodiments of the invention may allow a user to define multiple animation structures.

An animation structure comprises a plurality of items (or nodes or functional units) and one or more connections between respective items. In summary, each item represents a respective operation (or data processing or functionality or computation or calculation) that may be performed when performing the update (e.g. providing initial values for object attributes, or updating/calculating intermediate and/or final values for the object attributes, or calculating intermediates needed for computation or secondary data associated with the object such as marking that significant events have occurred during the animation, or calculating non-attribute values, such as an adjusted time-value), whilst a connection between two items represents that data output by the operation represented by one of those two items is input to the operation represented by the other of those two items. For example, an operation represented by a first item may calculate an intermediate (or temporary) value for an object attribute and output this as data to an operation represented by a second item that takes this intermediate value and processes it to form a different value for that object attribute. The functionality represented by an item in the structure may, indeed, be any particular functionality that may be useful or required for implementing an update process (from a complex blending of data from two or more animation sources to more simple operations such as arithmetic on data values).

In the description that follows, the term “graph” shall be used, but it will be appreciated that this may mean an animation structure or an animation network. Similarly, the term “node” shall be used, but it will be appreciated that this may mean an item or a unit or an element of the graph which may be connected (or linked) to other nodes of the graph via connections of the graph. As mentioned above, a node represents various processing to be performed for the update process of the animation. In the description that follows, the concept of “node” and the concept of “processing represented by the node” are sometimes used interchangeably—this is simply to improve the clarity of the disclosure.

FIG. 6 schematically illustrates an example user interface 600 according to an embodiment of the invention. The user interface 600 is displayed on the monitor 120 of the computer system 100 of FIG. 1. The user interface 600 is generated by the processor 108 executing one or more of the computer programs (stored as described above) according to embodiments of the invention as described below.

The user interface 600 comprises a graph definition area 602, a menu area 616, an information area 610 and a node selection area 612, as discussed below.

The graph definition area 602 displays a representation of an update process for an animation of an object 200 in the form of a graph. A dashed shape 604 in FIG. 6 encompasses a graph that is composed of various nodes 606 that are linked together (i.e. are interconnected) via respective connections 608. The nodes 606 are represented in the graph definition area 602 as functional blocks (or boxes) whilst the connections 608 are represented in the graph definition area 602 as lines between the various blocks. In preferred embodiments, the block representing a node 606 displays a name for that node 606 (to thereby display an indication of the processing or functionality associated with the operation represented by that node 606). It will be appreciated that embodiments of the invention may make use of other ways to visually represent nodes 606 and connections 608.

The user may select one of the nodes 606 or one of the connections 608 by using the mouse 126 to position a cursor (not shown in FIG. 6) displayed on the monitor 120 over the desired node 606 or connection 608 and then pressing a button of the mouse 126. However, it will be appreciated that embodiments of the invention may make use of other methods to allow the user to select nodes 606 and connections 608 (e.g. by using a Tab key on the keyboard 124 to switch the current selection from one node 606 or connection 608 to another node 606 or connection 608).

The user may delete a node 606 from the graph by selecting the node 606 and then pressing a Delete key on the keyboard 124.

The user may move a node 606 within the graph definition area 602 by selecting the node and, in doing so, keeping the mouse button depressed and then moving the mouse 126 to position the cursor (and hence the node 606) at the desired position within the graph definition area 602.

As will be described in greater detail later, there are many different types of node 606, each node type corresponding to a respective particular operation that may be performed when performing the update. The node selection area 612 displays one or more node type indicators 614, each representing a respective node type.

In order to add a node 606 of a particular node type to the graph being displayed in the graph definition area 602, the user may select the corresponding node type indicator 614. For example, the user may use the mouse 126 and double-click on the node type indicator 614. The user interface 600 is then arranged to add a node 606 of that node type to the graph and display that node 606 within the graph definition area 602. The user may then position the newly added node 606 within the graph definition area 602 as described above. Alternatively, the user may perform a drag-and-drop operation to drag a node type indicator 614 from the node selection area 612 into the graph definition area 602 to thereby place a node 606 of that node type within graph definition area 602.

As shown in FIG. 6, a node 606 is depicted in the graph definition area 602 with one or more small circles (sometimes referred to as “pins”) which represent data inputs and data outputs for the operation represented by that node 606 (or data inputs and outputs for the node 606). A node 606 may have zero or more data inputs and/or one or more data outputs. Each data input and data output is associated with respective data value(s) that the node 606 expects to receive as an input or transfer as an output. As an example, the data values could be time, transform data for the entire object 200, transform data for one or more parts of the object 200 (e.g. transform data just for the head or a limb of a person), effector data representing one or more effectors for the object 200, etc., and a node 606 may have, for example, three inputs, one of which is intended for receiving time data, another of which is intended for receiving transform data and another of which is intended for receiving effector data. An indication of these data values may be displayed next to the respective circle for the data input or data output to guide the user accordingly. Usually, data inputs are displayed via circles on the left hand side of the block representing the node 606 and data outputs are displayed via circles on the right hand side of the block representing the node 606 (but it will be appreciated that this “convention” need not be followed). A user may add a connection 608 between a first and a second node 606 by selecting one of the small circles on the first node 606 and then selecting one of the small circles on the second node 606, or by performing a drag-and-drop operation between an output circle of one node 606 and an input circle of the other node 606 (or vice versa). In doing so, the user interface 600 may check that the data type for the output is compatible with the data type for the input for this new data connection 608 (to ensure, for example, that time data is not going to be output via the new connection 608 to an input that expects to receive transform data or that effector data is not going to be output via the new connection 608 to an input that expects to receive time data). If the user interface 600 detects such an incompatibility then it may warn the user (via a message box displayed on the monitor 120) and not add the connection 608. A user may delete a connection 608 by selecting that connection 608 and pressing a Delete key on the keyboard 124.
In FIG. 6, the connections 608 are illustrated by two different styles of line: solid and dashed. The connections 608 illustrated by solid lines indicate that those connections 608 represent that the data output by a first node 606 and input to a second node 606 does not include effector data. Conversely, the connection 608 illustrated by a dashed line indicates that that connection 608 represents that the data output by a first node 606 and input to a second node 606 includes effector data. The graph defined by the user in graph definition area 604 may therefore include connections 608, as shown by a dashed line, which represent the flow of effector data between nodes 606 in the graph. Therefore, the graph may contain nodes 606 which receive at their input effector data that has been output by another node 606 and/or may provide effector data as an output (i.e. effector data may be input to and/or output from a node 606). Although dashed and solid lines have been used in FIG. 6 to illustrate the distinction between connections which represent a flow of effector data (as illustrated by the dashed lines) and those that represent a flow of data which does not include effector data (as illustrated by the solid lines), it will be appreciated that in embodiments of the invention, there may be no discernible difference between the representations of these two different types of connections 608 in graph definition area 604. Alternatively, the distinction between these two different types of connection 608 may be indicated in different ways in graph definition area 604, for example different colours may be used to indicate the different connection types or alternatively the distinction may be apparent by information displayed in information area 610, which is discussed in more detail below.

It will be appreciated that embodiments of the invention may make use of other user interface and user interaction techniques to allow a user to add connections 608 to and delete connections 608 from the graph that is being defined within the graph definition area 602. It will also be appreciated that embodiments of the invention may make use of other user interface and user interaction techniques to allow a user to add, move and delete nodes 606 from the graph that is being defined within the graph definition area 602.

The information area 610 may display any relevant information. For example, when a user selects a node type indicator 614 or a node 606, then information regarding the operation associated with a node of the type indicated by that node type indicator 614 or with that node 606 may be displayed in the information area 610. The information area 610 may also have one or more controls (which may change depending on the current context of the user interface 600, e.g. which node 606 or connection 608 has been selected) via which the user may select or input various properties or parameters for the graph or a particular node 606 (e.g. properties or parameters for a node 606 or a connection 608 which has been selected by the user).

The menu area 616 may have one or more selectable menus 618 via which the user may perform a variety of tasks, such as loading a graph (or animation definition) for display as a graph in the graph definition area 602 (so that the user can continue to define that graph or can use that loaded graph as a template to form new graphs) and saving the currently defined graph (or animation definition). The graphs may be loaded from or saved to the storage medium 104 or the data storage device 122.

It will be appreciated that the particular layout of the user interface 600 described above with reference to FIG. 6 is purely exemplary and that embodiments of the invention may make use of other forms of user interface, with other types of controls (such as buttons, check-boxes, radio buttons, etc.) to allow the user to interact with the user interface. Preferably the user interface used in embodiments of the invention allows the user to define a graph to represent an update process for an animation of an object 200, where the graph comprises nodes that are connected by one or more connections, whereby one or more of the connections may represent that effector data that is output by one node is received as input to another node, the user being able to add and remove nodes and connections as appropriate in order to arrive at the required representation of the update process.

FIG. 7 illustrates an example graph that may be constructed using the user interface 600.

As illustrated, data may be passed from a source node to one or more target nodes. This is shown in FIG. 7 by arrows on the connections between the nodes, although in embodiments of the invention the user interface 600 need not make use of arrows as the direction of flow of data is usually clear from the context (data outputs being on the right of a node and data inputs being on the left of a node). The graph shown in FIG. 7 is therefore “directed”, meaning that the direction of the flow of data between nodes of the graph is specified. The data being passed between two nodes via a connection may represent any values, or data entities, or properties/aspects, or effectors/constraints for an animation, and may, for example comprise values corresponding to one or more attributes of the object 200 associated with the animation whose update process is represented by the graph, values representing time, values representing volatile intermediate data needed only during the computation for the update process, values representing control parameters, static data, data received from the application that executes the update process (e.g. a computer game), or effectors representing one or more constraints or targets to be applied to the object 200, etc. Thus, some or all of the data being passed between two particular nodes may relate to object attributes; similarly, though, some or all of the data being passed between two particular nodes may relate to data/values that do not represent object attributes.

In FIG. 7, there are 8 nodes (nodes A-H) and various data values 1-9 that are passed between the nodes A-H or that are output, as described below:
the operation represented by node A outputs data values 1 to be inputs to the operations represented by nodes D and E;
the operation represented by node B outputs data values 2 to be inputs to the operation represented by node D;
the operation represented by node C outputs data values 3 to be inputs to the operations represented by nodes E and H;
the operation represented by node D receives and processes data values 1 and 2, to generate and output data values 4 and 5, with data values 4 being output to the operation represented by node F and with data values 5 being output to the operations represented by nodes F, G and H;
the operation represented by node E receives and processes data values 1 and 3, to generate and output data values 6, with data values 6 being output to the operation represented by node G;
the operation represented by node F receives and processes data values 4 and 5, to generate and output data values 7;
the operation represented by node G receives and processes data values 5 and 6, to generate and output data values 8; and
the operation represented by node H receives and processes data values 3 and 5, to generate and output data values 9.

The data values 7, 8 and 9 are the final output from the update process represented by graph shown in FIG. 7. Thus, the data values 7, 8 and 9 (being the data values which are not passed onto a subsequent node) may be values to which the attributes of the object 200 are to be set as a result of the update process for the object 200. In FIG. 7, the update process is shown as setting an attribute X to the value represented by data values 7, setting an attribute Y to the value represented by data values 8, and setting an attribute Z to the value represented by data values 9. The data values 7, 8 and 9 could therefore represent, for example, values for the trajectory data (to update the position and orientation of the trajectory joint 404) and values for the geometric data (to update the position and orientation of one or more of the joints of the object 200 to thereby affect its posture).

FIG. 8 illustrates an example of a graph with four nodes, nodes A-D. This graph has a so-called “cyclic dependency”, as the values output from node D are dependent on the values output from node C, which are dependent on the values output from node B, which are dependent on the values output from node D. This cyclic dependency could lead to multiple possible computation results depending on the order in which various processing is performed. Hence, in preferred embodiments of the invention, the user interface 600 does not allow the user to create graphs in the graph definition area 602 that have a cyclic dependency. When a user attempts to add a connection 608 between two nodes 606, the user interface 600 checks whether a cyclic dependency would be created by the addition of that connection 608. This may be performed by an exhaustive recursion through the graph that would be obtained if that connection 608 were added. If a cyclic dependency would be created, then the user interface 600 may display a warning to the user that the addition of that connection 608 is not allowed (e.g. warning text in a message box displayed by the user interface 600), and the connection 608 is then not added to the graph. The graph shown in FIG. 7 does not have a cyclic dependency, and is therefore a so-called “directed acyclic graph”. Such a graph shall be referred to herein as a DAG.

Before discussing in detail the various types of node and the various rules that may be applied by embodiments of the invention, it is worthwhile mentioning at this point how the processor 108, when executing a computer program, would “evaluate” a DAG, i.e. would actually determine how to carry out the various processing operations specified by the DAG to perform the corresponding update process and then carry them out to determine the output values from the DAG. Embodiments of the invention may carry out the process described below each time the update process is to be performed. For example, when actually carrying out (or performing or outputting) the animation defined and represented by the DAG (e.g. when the processor 108 is executing a computer game in which a character is to be animated in accordance with the animation defined by the DAG), then for each video frame, the processor 108 carries out the update process for that character in accordance with the DAG as follows.

The processor 108 may generate a sequence (or ordered list) of nodes (or at least identifiers of nodes or the operations represented thereby), which shall be referred to below as an “operations queue”. The operations queue represents an order in which the various operations represented by the nodes of the DAG may be executed in order to correctly perform the update process as intended by the designer of the DAG. This may be referred to as “compiling” the DAG into an operations queue. A particular DAG may have many different valid operations queues, and there are many different ways of compiling a DAG into a corresponding operations queue, such as the so-called “width-first compilation” and the so-called “depth-first compilation”, as will be described in more detail below.

In order to generate an operations queue from a DAG in order to carry out an update process to update the value of a single specific attribute of an object 200, an operations queue is initialised to be empty (i.e. to identify no nodes 606) and then the node 606 of the DAG that outputs the final value for that attribute is added to the operations queue. Then, the operations to update each of the input data values for that node 606 (i.e. the data values on which that node 606 is dependent) are determined and the nodes 606 representing those operations are added to the operations queue. This is continued recursively for each of the nodes 606 added to the operations queue until no more nodes 606 need to be added to the operations queue. If a node 606 that is added to the operations queue has already been added to the operations queue, then that already-present occurrence of the node 606 in the operations queue is removed from the operations queue—thus, a node 606 will occur at most once in the final operations queue.

In a width-first compilation, each node 606 on which a given node 606 depends is added to the operations queue before determining what further nodes 606 need to be added to the operations queue to update the input data values for those added nodes 606. In depth-first compilation, as soon as a node 606 is added to the operations queue, then the further nodes 606 that are needed to update each of its input data values are determined and added to the operations queue.

Using the DAG of FIG. 7 as an example, a width-first compilation of the DAG would result in the following operations queues to update attributes X, Y and Z respectively:

Attribute X (using value 7): B A D F

Attribute Y (using value 8): B A C E D G

Attribute Z (using value 9): B A C D H

The above operations queues are constructed from right-to-left, but the processor 108 would execute the operations represented by the nodes 606 in the left-to-right order along the operations queues.

In contrast, a depth-first evaluation would result in the following operations queues:

Attribute X (using value 7): B A D F

Attribute Y (using value 8): C A E B [symbol] D G

Attribute Z (using value 9): C B A D H

In the operations queue for attribute Y, node A is encountered twice during the right-to-left recursion. Thus, when adding the second instance of node A to the operations queue (i.e. the left-most instance), the first instance of node A is cancelled from the operations queue (represented above by striking-through the right-most instance above).

In preferred embodiments of the invention, depth-first compilation is used as it requires fewer internal states to be maintained when the operations queue is evaluated. This is due to most nodes being stateless and their outputs depend only on their inputs and not on any internal node values. Thus in the width-first compilation for attribute Y, execution of the resulting operations queue would require the retention of data values 2 (the result of node B) while the operations represented by nodes C and E are performed in order to then be able to perform the operation represented by node D. In contrast, in the depth-first compilation, data values 2 may be used as soon as they are calculated, and they need not be stored thereafter.

Typically, when compiling a DAG for performing an update operation, many attributes of the object 200 will need to be updated, not just one. The processor 108 may construct an operations queue corresponding to updating multiple attributes by concatenating or merging/interleaving the operations queues that it compiles for each separate one of those multiple attributes. Once again, in doing so the processor 108 removes any duplicate nodes 606 from later in the operations queue since their operations will have already been carried out (or represented) at an earlier stage in the operations queue.

The resulting queue will depend on the order in which the attributes of the object 200 are to be updated. The operations queue for requesting and obtaining updated values for attributes X, Y and Z in turn in a depth-first compilation would then be B A D F C [symbol] E [symbol] G [symbol] H, or just B A D F C E G H once duplicates have been removed (as illustrated by the strike-through above).

It should be noted that the formation and execution of an operations queue as described above is merely one example method of carrying out an update process represented by a DAG and that embodiments of the invention may make use of other methods for compiling/executing a DAG. In some embodiments, when executing an update process the processor 108 may not actually generate a queue (or list) with an explicit ordering of operations. For example, the processor 108 may form an (unordered) list by adding elements to a list, each element representing or identifying a corresponding operation/node and having references/links to any operations/nodes that depend on that corresponding operation/node and on which that corresponding operation/node depends. When adding an element to the list, the processor 108 may also store the fact that an element representing the corresponding operation/node has now been added to the list so that if the processor 108 encounters that operation/node again during compilation of the DAG, then it does not add another element to identify that same operation/node to the list, nor does it need to re-evaluate the dependencies of that node. This results in an unordered linked list of operations. The processor 108 may execute the update process by a recursive trace analogous to the compilation process: the processor 108 may trace through the list depth-first until an element is encountered which has no further dependencies; the processor 108 may then execute the operation that element references; the processor 108 may then delete that element from the list 108 and then move back along the list to a previously encountered element, and continue to trace depth-first from there until another element is encountered which has no further dependencies, and so on, repeating the above procedure.

The following description shall refer to the generation and execution of operations queues. However, it will be appreciated that the following description applies analogously to embodiments in which the processor 108 is arranged to compile and execute a DAG using any other alternative (non operations queue) method, such as the unordered linked list method described above.

The flexibility in the resolution of node dependencies also allows for any independent sub-graph (i.e. a section of the graph which does not depend on itself) to be evaluated together, i.e. all its nodes appear in sequence in the operations queue. In the example DAG shown in FIG. 7, the processor 108 could separate out nodes A, B, C and E as an independent sub-graph, construct the operations queue for that independent sub-graph, and then evaluate it before the rest of the graph. The resulting queue would then be B A C E followed by D H G F. As this independent sub-graph has no inputs from the rest of the graph (it has no external dependencies), the processor 108 could safely evaluate it (i.e. determine the output data values 1, 2, 3 and 6) before even constructing the operations queue for the rest of the graph.

The group of nodes A, D and G could not form a sub-graph because that group would both depend on, and be depended on by, node E, thereby creating a cyclic dependency.

Data values output from a node 606 need not always depend on all of the data values input to that node 606. Moreover, each output data value may depend on a different combination of the input data values from one execution of the update process to the next. Additionally or alternatively, the graph may represent several modes of operation, and in one or more of these modes some data values are used whilst in other modes those data values are not used. As an example, the graph may have a “switch node” that has two inputs, the first one receiving an on/off flag and the second one receiving a signal that the node passes through and outputs only when the first input receives a value representing “on”. If the first input receives a value representing “off” then the output of the switch node no longer depends on the second input. As will be appreciated, there are many more complex ways in which the dependencies between the output data values and the input data values of a node 606 vary depending on the particular input data values.

Thus, when compiling a DAG into an operations queue, preferred embodiments do not construct an operations queue that includes operations which calculate data values that go unused (as otherwise execution of the operations queue would unnecessarily waste processing time and resources). In such embodiments, one or more of the data values (such as the above “on/off” input data value for the switch node) may be identified as being control parameters that affect the internal dependencies between the output data values of a node 606 and the input data values for that node 606. The processor 108, when compiling the DAG into an operations queue, is then arranged to derive all of the control parameters from an independent sub-graph which has no external dependencies. As previously mentioned, the processor 108 may then evaluate this independent sub-graph (to determine the values of the control parameters) before it compiles the rest of the graph into an operations queue for the update process. With all of the control parameters being up-to-date, the processor 108 can use these control parameters to control the path of recursion during compilation of the rest of the graph.

Referring again to the example DAG of FIG. 7, consider the situation in which data value 5 input to nodes G and H represents a control parameter which, when non-zero, completely determines the output from the operations represented by nodes G and H (namely the data values 8 and 9), so it is only when data value 5 is zero that data values 6, and therefore node E, and data values 3, and therefore node C, are required. The processor 108 could pre-evaluate the independent sub-graph A B D to thereby determine the value of the control parameter represented by data value 5. Using the results of this, the processor 108 may then determine the operations queue needed to evaluate the rest of the network, i.e. either C H E G F (if data value 5 is zero) or just H G F (if data value 5 is non-zero).

As discussed below, in preferred embodiments of the invention the user interface 600 uses certain graphical representations, and implements certain tools, to make it easier for the user to construct complex, but flexible graphs that are easy for the user to comprehend (i.e. understand the intended purpose and nature of the animation being represented by the graph displayed in the graph definition area 602). This is described in more detail below. However, it will be appreciated that these features of the user interface are not essential, but merely serve to make the user interface more intuitive and more flexible for the user to construct or design a graph to represent an animation.

The flow of data from one node 606 to another node 606 is preferably not identified using arrows on the connections 608 (although arrows are shown in FIGS. 6 and 7 for ease of explanation). Instead, in preferred embodiments, the inputs and outputs for a node 606 are identified by the convention that input data values are indicated as entering a node 606 on the left side of the node 606 and output data values are indicated as leaving a node 606 on the right side of the node 606. This convention could, of course, be reversed, or even an upwards-downwards relationship could be used instead. Connections 608 between nodes 606 are then illustrated by lines terminated by small circles (the circles representing inputs and outputs for the particular data value or data values being input or output, as shown in FIG. 7). As described later, arrows on lines are used to represent transitions between states in state machines nodes.

The data passed from one node 606 to another node 606 via a connection 608 may, as mentioned above, represent anything of relevance to the animation. In particular, the data may represent one or more of the following, although it will be appreciated that other data representing other aspects of an animation may also be passed by connections 608 between nodes 606:
Data representing values for one or more attributes of the object 200, such as transform data. This may be performed by passing absolute values to represent these one or more attributes (e.g. actual values to specify geometric data) or values to represent how one or more attributes are to change from one time-point to a subsequent time-point (e.g. a trajectory delta to specify how an object's position has changed from one frame to the next frame).
Data representing “time”. In most embodiments, time is a value that is passed through unchanged by many nodes 606. A blend node (discussed later) may convert an input time data value from some real-world value (representing an actual time within a game or an application) to an event-space offset (representing a time within a blend operation).
Data representing “events”. Events are time-based data associated with animations. They may be used to control the evaluation of the network, or they may be used for unrelated purposes. An example event is a piece of markup data associated with an animation of a person walking or running that identifies when the person's footsteps occur in the animation. These events may be used in a game to trigger sound effects for the footsteps—for example, a computer game may use the events data output from the execution of an update process and the associated operations queue to determine when to output a sound effect for a footstep. As is known in this field of technology, when blending different running/walking/etc. animation sources together, the processor 108 may synchronise the footstep events from the different animation sources so that a smooth blend without undesirable artefacts is achieved. A blend node that represents such a blending operation may also determine and output event data that represents when the footsteps occur in the output blended animation. It will be appreciated that other events, representing other timings of other occurrences in an animation, may be represented by event data passed between nodes 606.
Data representing control parameters (as discussed above).
Data representing values which are not related to object attributes (such as a computation of a trigonometric function).
Data representing effectors for, or to be applied to, the virtual object 200.

A node 606 may have one or more input data values that affect its function, but that are static (i.e. they assume the same value for every update process that is performed during the animation). The user interface 600 does not necessarily display such input data values within the graph definition area 602. However, the user interface 600 may display them to the user and/or allow a user to update them within the information area 610, for example when that node 606 has been selected by the user. An example of such an input data value would be a setting on a “blend node” (i.e. a node that blends or merges data from two different animations) to define which type of blend to use (e.g. which data to take from one animation and which data to take from the other animation and how, or in what proportion, these data are to be combined).

Some data values are part of a group, with the data values in this group always being passed together from a source node 606 to a target node 606. For ease of illustration on the graph definition area 602, the user interface 600 may represent such a group of data values as a single data value rather than representing each data value separately. Hence, a data value output by a node 606 or input to a node 606 may in fact be a single data value or a plurality (e.g. an array or a structure) of data values. This is illustrated in FIG. 9, which shows how three data values Y1, Y2 and Z, which are always passed together between a source node A and a target node B may be illustrated in the graph definition area 602 as a single compound data value X. For example, Y1, Y2 and Z may be effector data representing single respective effectors, and then X is effector data representing a set of three effectors. This frees more space on the graph definition area 602, making it less cluttered and making it easier for the user to understand the graph.

In some embodiments of the invention, the user interface 600 represents, or identifies, the contents of a compound data value by using multiple coloured circles next to the input or output that receives or provides that compound data value. For example, a red circle may be used to indicate that transform data for this object 200 is input/output; a green circle may be used to indicate that time data is input/output; a cyan circle may be used to indicate that event data is input/output; a yellow circle may be used to indicate that effector data is input/output. Of course, other data types may be involved in compound data values and other methods of representing the data types involved in compound data values may be used.

The user interface allows compound data values to be separated into subsets of its component data values, so that these subsets can be processed separately. However, preferred embodiments only allow this to happen inside an independent sub-graph of the graph being generated within the graph definition area 602. These embodiments identify this independent sub-graph using a type of “container node” (described below) called a compositor. Compositors isolate the parts of the graph where compound data values are not necessarily in their normal well-defined groupings.

FIG. 10 illustrates a node type called a grouper node which the user interface 600 may provide to allow the user to manage compound attributes. A grouper node groups received input data values and outputs a compound data value that comprises those input data values. Continuing from the example shown in FIG. 9, X is a compound data value containing data values Y and Z, where Y is a compound data value containing data values Y1 and Y2. Two grouper nodes may be used (as shown in FIG. 10) to create the compound data values Y and Z. Preferably, the user interface 600 restricts the placement of grouper nodes to being with the container node representing a compositor—in this way, the normal groupings of data values into a compound data value can be preserved at all places except in compositors where it may be desirable to separate out and operate on specific data values within a compound data value.

Preferably, grouper nodes have two inputs, which shall be referred to below as a “base” input and an “override” input. The grouper node has settings, i.e. static input data values which may be set by the user (e.g. via input controls that the user interface 600 makes available in the information display area 610 when the grouper node has been selected by the user). These settings identify which specific data value(s) (e.g. object attributes associated with specific joints of the object 200) are to be represented by input data values received at the override input. The base input may receive input data values for any data values (e.g. any object attribute). The grouper node will then group together the data values received at the override input and the base input—if a data value received at the override input represents the same thing as a data value received at the base input (e.g. represent the same body part for the object 200), then the grouper node uses that data value received at the override input to form the output compound data value, and ignores that data value received at the base input, i.e. the override input takes priority over the base input if there is a conflict between the data values received at these two inputs

In preferred embodiments of the invention, if the user uses the user interface 600 to connect a compound data value output by a first node 606 to an input of a second node 606 via a connection 608, where that input is only intended for a subset of the data values contained within the compound data value, then the user interface 600 considers that connection 608 to only be passing that subset of data values to the second node 606. Continuing with the examples of FIGS. 9 and 10, FIG. 11 illustrates how a first node may have an output that outputs the compound data value X, and a connection has been made from this output of the first node to inputs of three other nodes that respectively only expect to receive data values Y1, Y2 and Z. The user interface 600 will therefore consider the connections between the first node and these three other nodes to be connections just for the data values Y1, Y2 and Z respectively, despite being connected to an output that outputs the compound data value X.

As mentioned above, a sub-graph is a group of connected nodes which does not depend on itself. In the example DAG of FIG. 7, the group of nodes E, G and H forms a sub-graph. In embodiments of invention, the user interface 600 allows the user to group a sub-graph of nodes together into a single container node, with the single container node replacing the individual nodes of the sub-graph. The user interface 600 displays the container node in the graph definition area 602 instead of the individual nodes that form the sub-graph being represented by the container node. In this way, more space is made available in the graph definition area 602 and a more intuitive and comprehensible graph definition is displayed to the user. This is illustrated in FIG. 12 which illustrates how the user interface 600 allows the user to replace nodes E, G and H with a single container node “EGH Group”. Preferably, container nodes are distinguished from non-container nodes by using boxes with sharp corners for container nodes and rounded corners for non-container nodes. It will be appreciated, however, that other methods to visually distinguish between container and non-container nodes may be used.

As mentioned above, the nodes A, D and G cannot form a sub-graph as that sub-graph would both depend on, and be depended on by node E, creating a cyclic dependency. Thus, nodes A, D and G cannot be replaced by a single container node. The user interface 600 does not allow a user to create a container node that would involve such cyclic dependencies.

The user interface 600 may allow a user to edit the contents of a container node (e.g. which nodes form the sub-graph of nodes of the container node and how the nodes of the sub-graph are linked by connections, if any). The user interface 600 may, for example, allow the user to select a container node and double-click on it, or select the container node and press an Enter key on the keyboard 124. In doing so, the current graph (containing the container node) displayed on the graph definition area 602 may be replaced by a graph representing the sub-graph for the container node. This graph may then be edited by the user accordingly, as described above. The user may return to the previous graph by pressing a certain key on the keyboard 124 or selecting a button on the user interface 600 or double-clicking on a location in the graph definition area 602 that does not contain a node 606 or a connection 608. As container nodes may, themselves, contain other container nodes, a hierarchy of levels within the overall graph may be achieved and the user may navigate through the various levels as described above to edit the various graphs and sub-graphs accordingly.

To pass data values into and out of a container node from the rest of the graph, the user interface 600, when displaying the graph for a container node, may display simulation input and output nodes for this purpose. FIG. 13 illustrates an example of this for the “EGH Group” container node of FIG. 12. FIG. 13 shows a sub-graph that may be displayed in the graph definition area 602 when, for example, the user double-clicked on the “EGH Group” node of the graph of FIG. 12 when that graph was displayed in the graph definition area 602.

An input node may be used to make it possible to connect parts of the sub-graph represented by the container node to data values from any other part of the graph without the need to explicitly represent the actual connection 608 to those other parts of the graph (i.e. without having to explicitly show connections to other levels of the graph hierarchy, e.g. the higher level shown in FIG. 12). These data values may just be global inputs with no source node, or may be from a particular node (or nodes) within the graph (but external to the sub-graph).

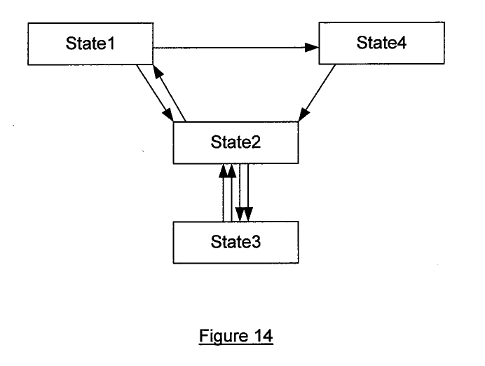

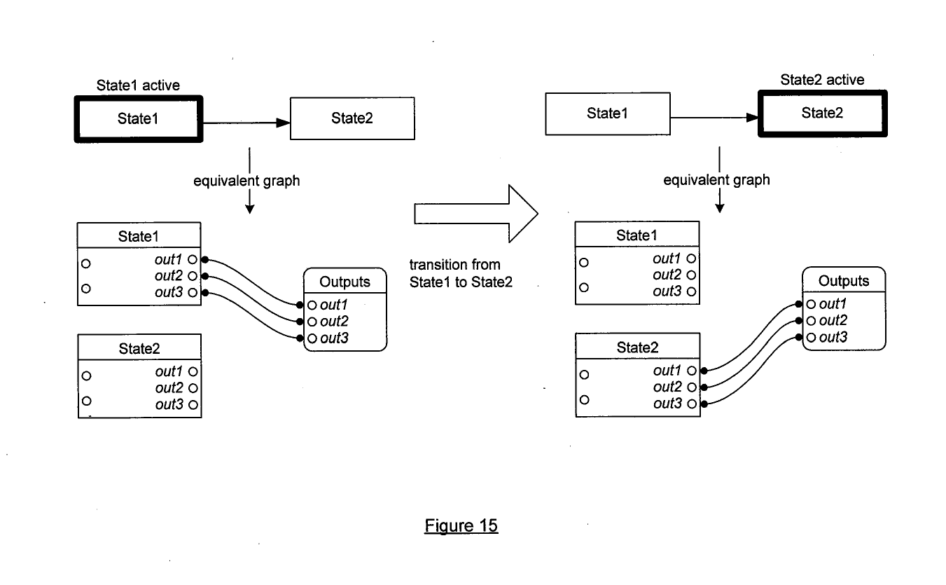

One particular type of sub-graph container is a state machine. The nodes of a sub-graph of the state machine container are called “states” or “sister states”. Each state is then a container node itself having its own sub-graph of nodes to represent processing for that particular state of the state machine. The state machine container node represents a finite state machine in which only one state may be active at any point in time (except during a transition between states). The sister states contained within the same parent state in a hierarchical state machine all have the same types of output data values. Thus, no matter which state is the currently “active” state for the state machine, the state machine container node will output the same types of data values. The operation represented by a state machine node may involve, during an update process, transitioning from one state (the currently active state) to another state (a newly active state). In preferred embodiments, the possible transitions are represented by arrows between states. These transitions (and their arrows) may be added, deleted and edited in the same way as described above for connections 608. FIG. 14 illustrates the sub-graph of a container representing an example state machine. As shown in FIG. 14, there are four states represented by respective nodes “State 1”, “State 2”, “State 3” and “State 4”. The possible transitions between states are shown using arrows, namely:
for the update process, it is possible to transition from the processing for State 1 to the processing for State 2 or State 4;
for the update process, it is possible to transition from the processing for State 2 to the processing for State 1 or State 3;
for the update process, it is possible to transition from the processing for State 3 to the processing for State 2;
for the update process, it is possible to transition from the processing for State 4 to the processing for State 2.

It will, of course, be appreciated that other state machines, with greater or fewer states, and/or different arrangements of transitions, are possible.

The output from the state machine container node is provided by the output from the currently active state container node of the state machine container node, except possibly during a transition in which case the output from the state machine may be a combination of data from the currently active state to the soon-to-be active state. The currently active state is the state which has been transitioned to most recently (or, on start up, a default initial state).

In FIG. 14, there are two arrows from the State 2 node to the State 3 node. This is used to signify that there are different transitions from the processing for State 2 to the processing for State 3, for example different transitions based on different triggering events or conditions (e.g. triggering events in a computer game). Similarly, there are two arrows from the State 3 node to the State 2 node signifying that there are different transitions from the processing for State 3 to the processing for State 2. It will be appreciated that different numbers of arrows (other than 1 or 2) may be used between two states to indicate a corresponding number of possible transitions between those states.

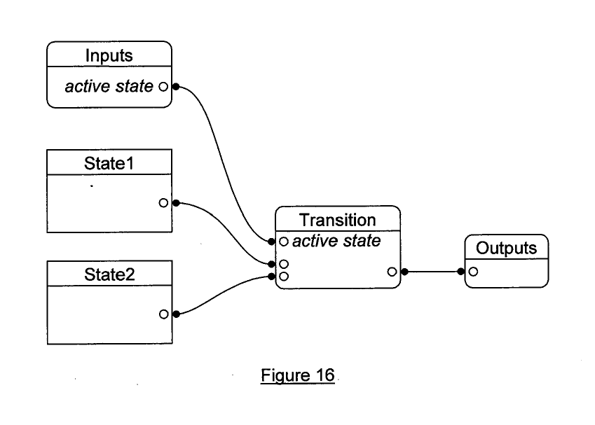

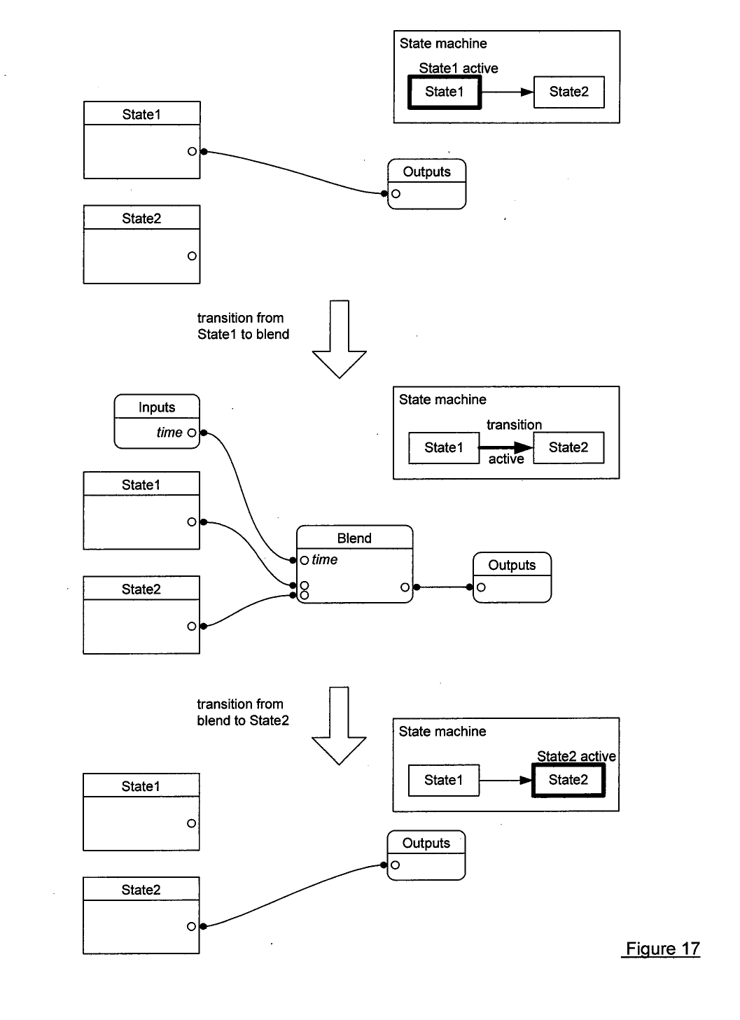

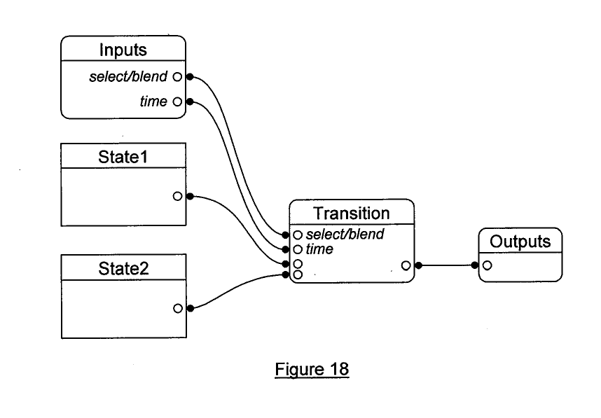

The user interface 600 may allow the user to specify numerous types of transition (e.g. by selecting a transition arrow and then setting one or more parameters for the selected transition in the information area 610). A first example transition is a “simple” or “instantaneous” transition which is arranged such that, for the update process, the output data values from a currently active state are no longer used (that state then no longer being active) and instead the output data values from another state (which is then active) are used instead as the outputs from the state machine node. This is illustrated in FIG. 15. The user interface 600 could represent this, for example, in graph form by using a transition node within the state machine node, where this transition node effects the switch of active state by passing through data values from one state node or another state node depending on a control parameter that is input to the transition node and that is used to control when to perform the transition, as illustrated in FIG. 16. An alternative example transition type is a “smooth” transition in which a currently active state and a newly active state have their output data values blended over time, for example to transition from running to walking a smooth transition could be used to provide an intermediate stage of jogging for a period of time—in this way, the output data values from a running state node may be combined with the output data values from a walking state node for a period of time. This is illustrated in FIG. 17. Again, the user interface 600 could represent this, for example, in graph form by using a transition node within the state machine node, where this transition node effects the switch of active state by passing through data values from one state node or another state node or a blend of data values from the two state nodes depending on a time data value and a control parameter that are input to the transition node and that are used to control when to perform the transition, as illustrated in FIG. 18. It will be appreciated, of course, that other types of transitions could be used between state nodes within a state machine container node.

In preferred embodiments, some connections 608 may represent a two-way passage of data, in that a connection 608 between a first node 606 and a second node 606 may represent the output of a first set of data values from the first node 606 to be input data values to the second node 606 and, at the same time, to represent the output of a second set of data values from the second node 606 to be input data values of the first node 606. This breaks the “left-to-right” data flow convention mentioned above. Such two-way connections 608 shall be referred to as “functional connections”, whilst one-way connections shall be referred to as “data connections”. The user interface 600 still represents the functional connection 608 as a line from an output of one node (i.e. from a circle on the right side of a node's block representation) to an input of another node (i.e. to a circle on the left side of that node's block representation)—however, these circles no longer represent purely input or purely output interfaces to their respective nodes. An input or an output of a node 606 that expects to receive a functional connection 608 shall be referred to as a functional input or a functional output.

The use by the user interface 600 of functional connections makes visualisation of the graph within the graph definition area 602 much more simple than if the user interface 600 only made use of data connections, as will become apparent below.

The immediate result of functional connections is that every functional connection appears to create a cyclic dependency (which, as mentioned above, is undesirable), as the two nodes connected to each other via the functional connection appear to be dependent on each other. Embodiments of the invention prevent this by the user interface 600 imposing a number of rules when using functional connections, as follows:
1. A functional output may be connected to only one functional input, i.e. only one functional connection may be connected to a functional output.
2. Every functional node (i.e. a node 606 with a functional output) can have only one output (namely that functional output).
3. The operation represented by a functional node in fact has a separate process for each functional connection, so effectively the functional part of the graph is a definition of multiple independent graphs, consistent and acyclic in themselves, and which can be evaluated independently. In other words, a functional node may represent multiple separate DAG nodes, each one resolving a particular dependency—for example, a blend node may represent one operation for blending geometric data, one operation for blending trajectory data, one operation for blending event data; and, for each input animation source for the blend node, a respective operation that uses game time data and an event definition to calculate an event-space time index for that animation source, with all of these operations effectively being implemented as separate DAG nodes.

In most embodiments, time is the only data value that is passed in the “right-to-left” (unconventional) direction across a functional connection 608, but it will be appreciated that other embodiments may additionally or alternatively pass other data values representing other features of the animation in this right-to-left direction.

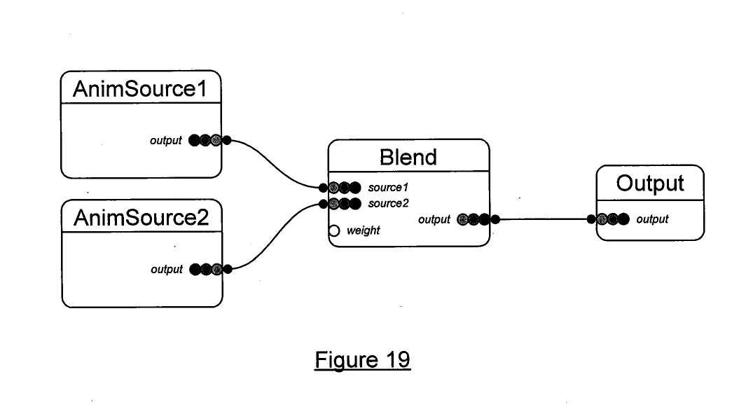

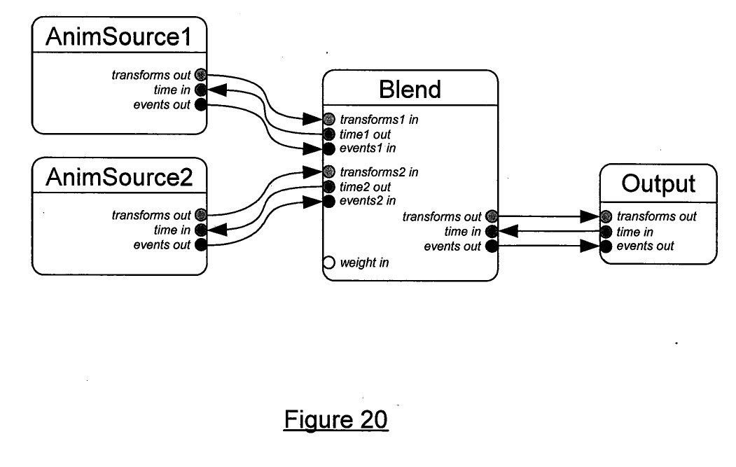

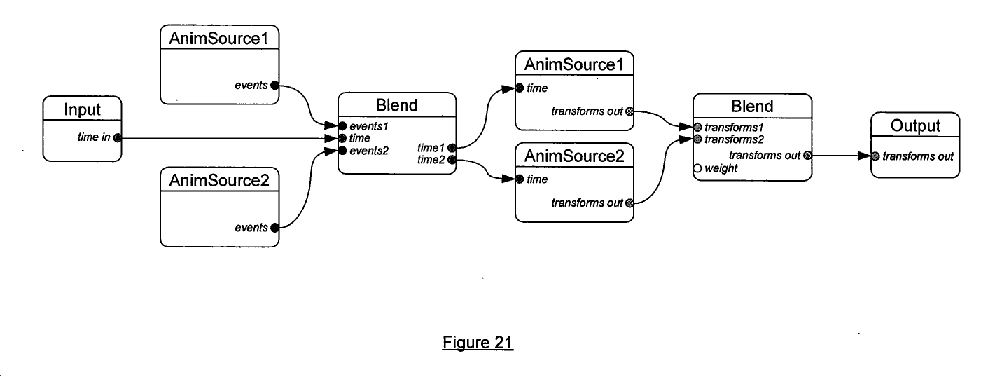

The benefit of functional connections 608 is illustrated with reference to FIG. 19, which illustrates the operation of a blend node (used in forming a “blend tree”). The function of these nodes shown in FIG. 19 will be explained later, but in summary, the “AnimSource1” and “AnimSource2” nodes are animation source nodes that represent respective operations that output respective data that define respective poses for the object 200 at a given point time. This data includes transform data (to represent the position and orientation of the object 200 and its parts) as well as event data (to represent events, such as footfalls, that may need to be synchronised when blending transform data from the two animation source nodes together). The “Blend” node represents an operation that interpolates between the two sets of transform data output by the animation nodes depending on the value of a weight control parameter (the control parameter sub-graph is not shown in FIG. 19), and outputs the results to an output node, and, when event data is being used, also represents an operation that interpolates between the respective sets of event data output by the two animation nodes and outputs 7 that result to the output node. For example, the AnimSource1 node may output data representing a person walking whilst the AnimSource2 node may output data representing that person running. The transform data output by these two nodes represents the respective walking and running poses for the person, whilst the event data output by these two nodes represents the respective timing of when footfalls occur during the walking or running. The Blend node may then interpolate, or combine, the transform data from the two animation sources and may interpolate, or combine, the event data from the two animation sources, with the interpolated transform data representing the pose of a person jogging and the interpolated event data representing when footfalls occur during the jogging animation. The weight control parameter sets how the interpolation occurs (e.g. how much the walking data and how much running data contribute to the final output). FIG. 20 shows how this graph might look after the functional inputs and outputs of FIG. 19 are expanded to expose their underlying components. As can be seen, functional connections have been used in order to represent passing time data in the right-to-left direction, with other data being passed in the left-to-right direction.

The way the processor 108 might execute the compilation and dependencies represented by the graph of FIGS. 19 and 20 as follows:
1. The game (or whatever application is using the animation defined by the graph of FIGS. 19 and 20) requests transform data with which to update attributes of the object 200 (e.g. so as to move the object 200 within the virtual world 202). The processor 108 may inspect/process the operations queue to determine an update for the transform data as described below.
2. The update requires evaluation of the transform data output by the blend node.
3. This requires the animation source nodes to output relevant transform data to the blend node for the blend node to interpolate to produce updated transform data.
4. To output transform data, the animation source nodes need an event-space time value in order to know which pose to output from their stored animation data. The animation source nodes can obtain this time data from the blend node (via the functional connections in the right-to-left direction).
5. To calculate this event-space time value, the blend node needs a ‘game time’ (in seconds, for instance) representing an actual time within the game, as well as the event data representing the event sequences from the animation source nodes. The game time is a direct input to the blend node (supplied by the game itself), while events data is provided to the blend node from the animation source nodes.
6. Consequently, the animation source nodes output their event data to the blend node.
7. The blend node calculates event-space time based on the game time and the received event data, and provides this to the animation source nodes
8. Wing the event-space time, the animation source nodes output their respective relevant transform data corresponding to the event-space time.
9. The blend node then blends the respective transform data from the animation source nodes to output blended transform data.

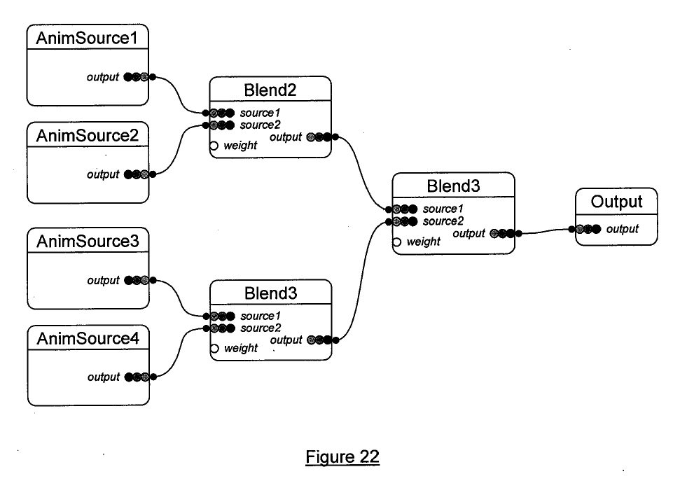

FIG. 21 illustrates the actual DAG which the processor 108 determines from the graphs of FIGS. 19 and 20 (based on the above execution sequence)—i.e. it is equivalent to the graph of FIGS. 19 and 20, but with no right-to-left passage of data (i.e. with no functional connections). This is more complex that the graph of FIG. 19 because the graph of FIG. 20 appears to contain cyclic dependencies between nodes (due to the functional connections), whereas the above-mentioned rules mean that a valid DAG (shown in FIG. 21) actually results from the graph of FIG. 19. However, the DAG shown in FIG. 21 is more complex than the graph shown in FIG. 19, and certainly the graph shown in FIG. 19 is more intuitive and comprehensible to the user than the DAG of FIG. 21.

Compilation of the DAG of FIG. 21 according to the usual depth-first dependency resolution rules would construct a valid operations queue for calculating transform data. If the game now requested event data to be output, the resulting compilation would create a different graph consisting of just one blend node taking the events1 and events2 input data, because its inputs have already been updated so it could calculate output events directly.

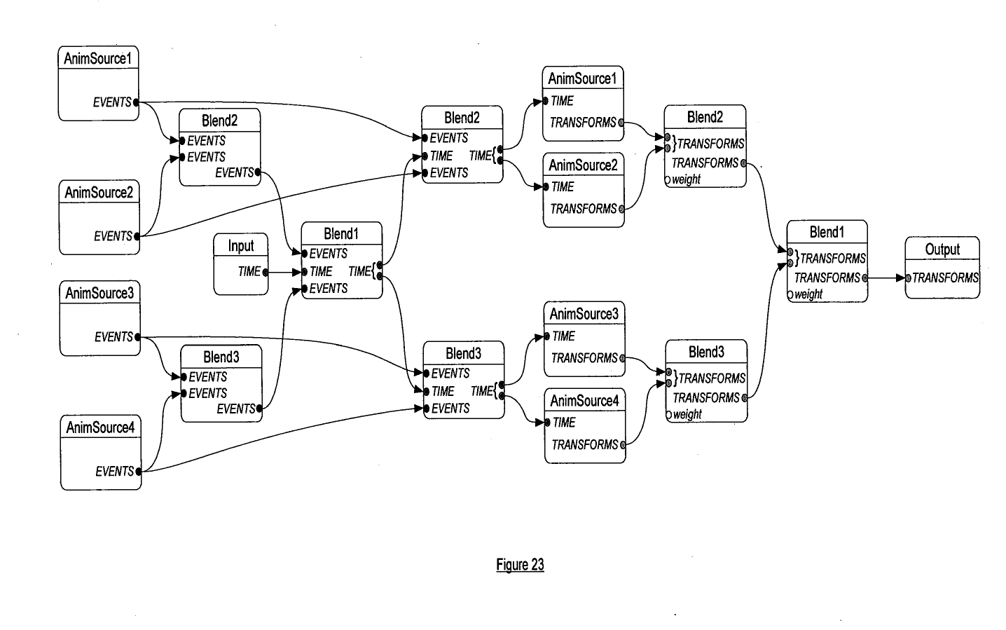

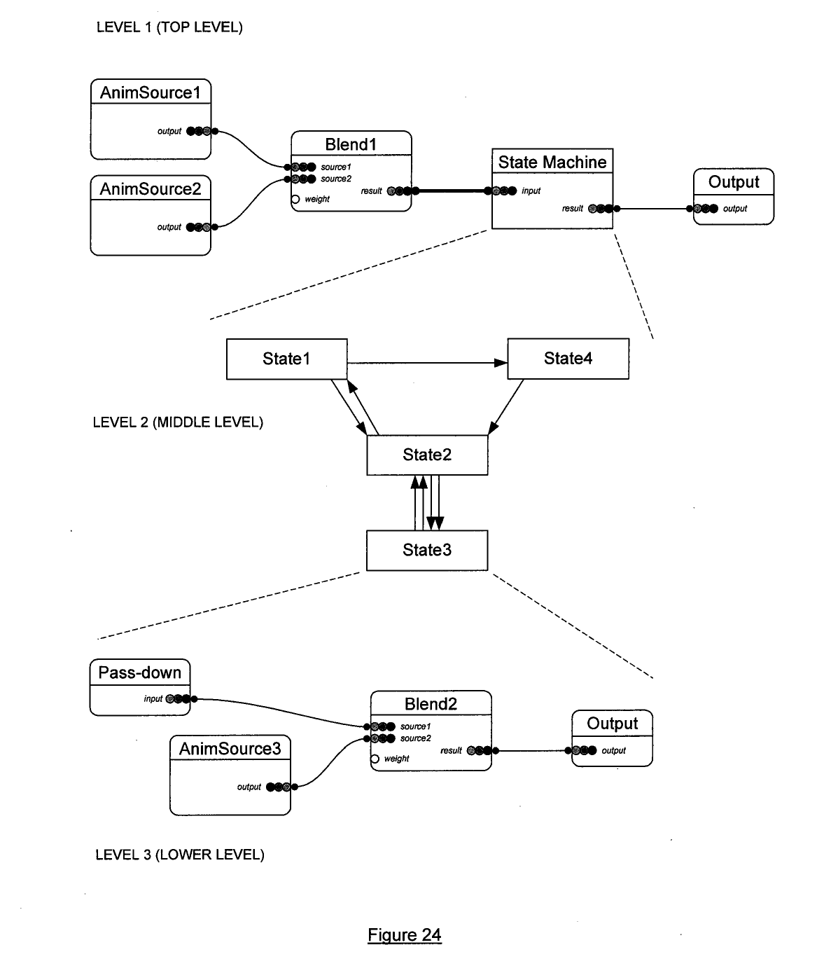

FIG. 22 illustrates an example two-level blend tree; FIG. 23 illustrates the corresponding DAG for the graph of FIG. 22. This further demonstrates how a user interface 600 according to an embodiment of the invention that makes use of functional connections 608 and the above-mentioned rules allows the user to define more intuitive and comprehensible graphs more easily. A user looking at the DAG of FIG. 23 would find it hard to determine the function of the DAG, and harder to author it in the first place. However the two-level blend tree graph of FIG. 22 which corresponds to the DAG of FIG. 23, by compounding the important attributes and focussing on the left-to-right flow of transform data and event data from animation sources to the output, is a much easier representation to grasp. The true complexity of the flow of time and event data is hidden from the user because the user does not need to know it precisely. Thus, embodiments of the invention 600 allow the user to author a graph in the graph definition area 602 in the more intuitive form shown in FIGS. 19 and 22 as opposed to requiring them to author a DAG (as shown in FIGS. 21 and 23) directly in the graph definition area 602. The above rules imposed by the user interface 600 ensure that a DAG (of FIGS. 21 and 23) can be validly formed from the graph (of FIGS. 19 and 22) created by the user as they ensure that the use of functional connections does not incur cyclic dependencies.

A number of types of nodes shall be described below. However, it will be appreciated that other node types could be used in addition or as alternatives in embodiments of the invention, with other operations being represented by those node types accordingly.

One node type is the so-called “animation source” node type (which has been introduced briefly above with respect to FIGS. 19-23). Animation source nodes are nodes with access to animation data (transform data and event data) that define a particular animation for a particular object 200 (e.g. animation data stored on the storage medium 104). They output transform data for the object 200 for a given time index, i.e. for a given point in time during the animation represented by this animation source node, the animation source node may output transform data to represent the position and orientation of the object 200 and its object parts during the animation at that point in time. The animation data may be stored as time-sampled data and, for a given input arbitrary point in time the animation source node may interpolate appropriately between two or more samples of transform data to generate and output transform data corresponding to that input point in time. Animation source nodes may also output any event data associated with their animation.

Another node type is the so-called “blend” node type which has been introduced at various points above. A blend node represents the interpolation between two or more sets of input transform data (e.g. sets of transform data received from animation source nodes, other blend nodes, or any other nodes in the graph, as shown, for example, in FIGS. 19-23). A blend node may be a “match events blend node” which uses event-space time indexing to ensure that the blending operation always synchronises certain events (such as footfalls for a person object 200) that have been marked up in the input animations. Such match events blend nodes may therefore: (a) obtain event data from animation sources (or other nodes) to determine when events will occur in the animations input to the blend node; and (b) calculate and provide different event-space time data to the animation sources (or the other nodes) to request transform data corresponding to different points in time (i.e. speeding up or slowing down of the input animation sources for the blend node) in order to ensure that events in the animations input to the blend node are always synchronised.

One example event is footstep—the timing of footfalls in two animations to be blended needs to be synchronised or else visually obvious artefacts are produced in the blended result (such as the feet sliding along the ground during a footstep). The use of footstep markup event data ensures this happens even when the two animations to be blended have significantly different timing, such as when blending a “walk” animation with a “limp” animation.

In some embodiments a blend node is arranged to interpolate only between two animations at a time. However, a blend node may have more than two inputs that receive respective animation data for blending and may select different pairs of input animation data depending on a “weight” control parameter input to the blend node. When, for instance, three animation source nodes are connected to a blend node, the blend node blends sources 0 and 1 when the weight control parameter is between 0 and 0.5 and blends sources 1 and 2 when the weight control parameter is between 0.5 and 1. The actual interpolation factor/weighting used for each blend/interpolation may be recalculated from the weight control parameter appropriately (so that it is between 0 and 1).

Another node type is the so-called “IK” or “Inverse Kinematics” node type. IK nodes represent operations for procedural animation which take an input and modify it to provide a modified output. For example, an IK node may be used to adjust the orientation of a joint in an arm or a leg of the human object 200 to bring a hand or a foot into an alignment with a given target position/orientation (as specified by an effector). This may be used, for example, to allow a game to ensure that the human object 200 reaches to pick up another object accurately or kicks another object accurately (i.e. makes contact with another object in a visually accurate and realistic manner), regardless of where that other object may be in the virtual world 202. As another example, an IK node may be used to adjust spine, neck and head joints for a human object 200 to make sure that the human object 200 appears to be looking towards (and maintains looking towards) a given target or position within the virtual world 202 (as specified by one or more effectors). IK nodes may contain embodied effectors (or constraints) which are to be applied to the virtual model, where these embodied effectors are hard-coded into the IK node. The IK node makes use of inverse kinematics, as described above, to apply these embodied effectors to the virtual model.

Another node type is the so-called “ID” or “Inverse Dynamics” node type. ID nodes make use of a physics engine, as described above, to apply physical constraints, such as collision detection, to the animation of a model. An ID node may simulate the application of physical laws (e.g. Newtonian mechanics), for example by simulating the application of one or more forces and/or torques to the object 200 so as to achieve a desired effect (for example, as specified by an effector).

As inverse dynamics and inverse kinematics are well-known to the skilled person, they shall not be described further herein.

Another node type is the so-called “operator” node type. Operator nodes are used for processing control parameters. Examples include adding, subtracting, scaling etc. of various data values. Other mathematical operations can be performed by operator nodes, such as calculating and outputting the sine of an input parameter. This could be used in conjunction with other operators, for example, as a simple way of varying blend weights smoothly back and forth to give a sinusoidally varying output to control, for example, a bobbing “head” or bouncing “tail” of an object 200.

Another node type is the so-called “grouper” node type. This node type has been discussed already above

Another node type is the so-called “blend tree” node type. A blend tree is a container node representing a continuously-connected sub-graph. Its sub-graph can contain any node or container type, except for grouper nodes.

Another node type is the so-called “compositor” node type. Compositors are blend trees that can contain a grouper node. Compositors have been discussed above.

Another node type is the so-called “state machine” node type and the so-called “state” node type. These node types have been discussed already above.

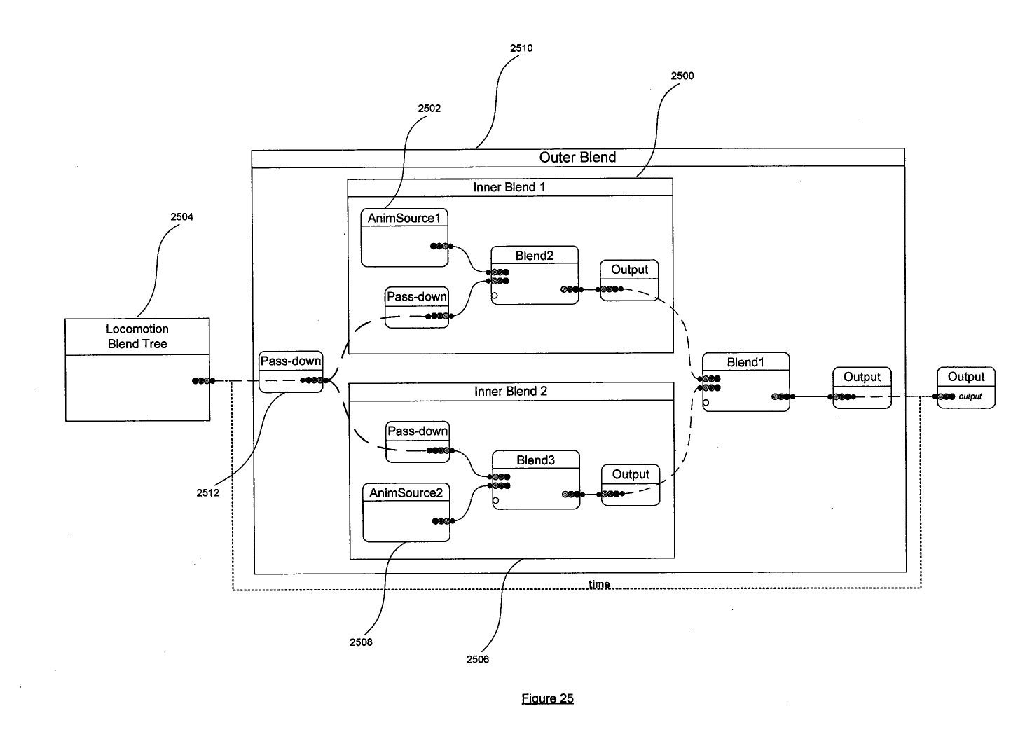

As mentioned above, the use of containers provides a hierarchical structure to the definition of a graph that represents an update process for the animation of an object 200. The sub-graph represented by a container node may itself have one or more further container nodes of one or more types. This applies to all types of container node (be they state machine nodes, states, blend trees, compositors, etc.). An example illustrating such a hierarchical representation of a graph for an update process for an animation is shown in FIG. 24. Navigation between levels of the hierarchy has been described above.

Indeed, the entire graph may be considered to be a hierarchy of state machines (or a hierarchical state machine), wherein each level of the hierarchy is a state machine having one or more states. When there is a single state there are, of course, no transitions. In the example of FIG. 24, the top level of the hierarchy may be considered to be a single state of a top level state machine; the middle level of the hierarchy represents a part of the single state represented by the top level state machine and itself is a state machine having four states; and the bottom level of the hierarchy represents one of the states of the middle level state machine and itself is a state machine having one state.

Another node type is the so-called “pass-down pin” node type. A pass-down pin represents an input of data into a container node, effectively passing data values down from a higher to a lower editing level within the above-mentioned hierarchy. Pass-down pins are particularly useful in certain situations, as illustrated by the example graph shown in FIG. 25. In the example of FIG. 25, a user has created a two-level blend tree, but has done so using multiple blend tree containers 2510, 2500 and 2506 (the containers 2500 and 2506 being nodes within the container 2510). A first blend is performed by a first inner blend tree container 2500 that blends animation data from a first animation source 2502 with animation data from another a blend tree 2504 labelled “Locomotion”. A second blend is performed by a second inner blend tree container 2506 that blends animation data from a second animation source 2508 with animation data from the “Locomotion” blend tree 2504. The outputs of the two inner blend trees 2500 and 2506 are then blended together by the outer blend tree container 2510. The dashed lines in FIG. 25 represent the effective connections being made across containment hierarchy levels by use of pass-down and output nodes. A pass-down pin 2512 of the outer blend tree container 2510 appears to have two functional connections from its output to the nodes of the two inner blend tree containers 2500 and 2506. This would appear to break the above-mentioned rules for using functional connections—in this example, it is not clear which inner blend tree container 2500 or 2506 should pass time data in the right-to-left direction to the Locomotion blend tree container (especially as the inner blend tree container 2500 or 2506 may have modified its input time data). However, embodiments of the invention do not violate the above rules as the user interface 600 may impose a further rule which specifies that right-to-left data (such as time) to be passed via a container node in the graph is not passed through and output from the container via the nodes of the container, but rather is passed directly from the node to which the container node is connected via its own output (in this case, the right-most output node). This is indicated in the graph of FIG. 25 by a dotted-line connection circumventing the outer blend container 2510, marked as ‘time’. In this way, data being passed from right-to-left avoid modification by nodes of the sub-graph of the container node, thereby avoiding any ambiguities that might otherwise arise if the nodes of the sub-graph were responsible for actually outputting a value for that data in the right-to-left direction. Thus, the pass-down pin 2512 does not effectively have multiple functional connections linked to its output, as the pass-down pin 2512 does not itself output data in the right-to-left direction. In embodiments of the invention, the user interface 600 makes use of pass-down pin nodes to effect this redirection of right-to-left data to circumvent container nodes. It should be emphasised that the right-to-left (time) data is still provided to the nodes within the container node—but this data is not output from the container node via the nodes within the container node.

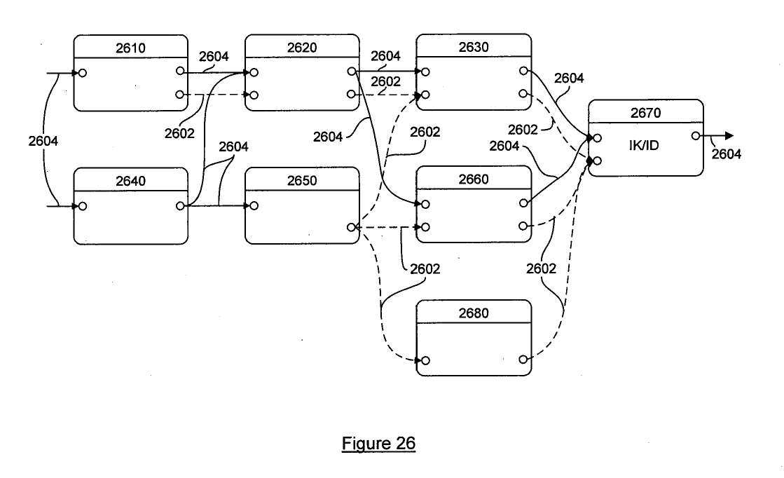

FIG. 26 schematically illustrates a graph 2600 according to the present invention. The graph 2600 contains a number of nodes 2610, 2620, 2630, 2640, 2650, 2660, 2670 and 2680 connected via a number of connections 2602 and 2604.

Each node 2610, 2620, 2630, 2640, 2650, 2660, 2670 and 2680 represents a respective operation which is to be performed when performing the update represented by the graph 2600. The respective operation for each node 2610, 2620, 2630, 2640, 2650, 2660, 2670 and 2680 produces output data for (or from) that node. The respective operation may operate on (or process or be based upon) some or all of the input data to that node. However, the node need not have any input data and the respective operation may instead generate the output data for the node, for example, based on a predetermined value or a random (or pseudo-random value). Similarly, whilst the output for the output data for the node is produced by the respective operation, the respective operation may simply “pass-through” some (or even all) of the input data unchanged, such that the output data may, at least partly, correspond to some or all of the input data.

Each connection 2602 and 2604 represents the flow (or passing) of data from a first node to a second node. In other words, each connection 2602 and 2604 represents that the output data generated by the operation represented by a first node 2610, 2620, 2630, 2640, 2650, 2660, 2670 or 2680 is input to the operation represented by a second node 2610, 2620, 2630, 2640, 2650, 2660, 2670 and 2680. Some connections 2602, shown in FIG. 26 with dashed lines, represent the flow of effector data, which is data representing one or more effectors for the object 200. Other connections 2604, shown in FIG. 26 with solid lines, represent the flow of non-effector data, which is data which does not represent effectors for the object 200, such as, for example, one or more of topological data, geometric data, physical data, trajectory data, skinning data and/or rendering data. It will be appreciated that other types of non-effector data may flow between nodes. Whilst the connections 2602 and 2604 have been illustrated as separate connections in FIG. 26, it will be appreciated that these may also be represented as a single composite connection which may include either effector data or non-effector data or a combination of both.

The respective operations represented by the nodes 2610, 2620, 2630, 2640, 2650, 2660, 2670 and 2680 may perform a variety of functions, as discussed further below:

(a) The respective operation for some nodes may include the creation of one or more effectors for the object 200. The created effector(s) may be created based upon non-effector data that is input to the node. For example, continuing the earlier example of the person and the skateboard illustrated in FIG. 4, a node may receive, as an input, geometric data indicating the location of the ankle joint of the person and the surface of the skateboard. Based on this geometric data, the node may create one or more effectors which specify a target/desired position for the ankle joint of the person to ensure that the sole of the person's foot coincides and aligns with the surface of the skateboard. Additionally, or alternatively, the created effector(s) may be created based upon effector data that is input to the node. As an example, a node may receive, as an input, effector data specifying a target location for a hand of a person. The node may use this information to create an effector which specifies an appropriate effector for the person's other hand in order to provide an animation of the person holding a box. Similarly, given the input effector data specifying the target location for the hand of the person, the node may create an effector that specifies a target location for the elbow of the person to ensure that the elbow is lower (in the virtual world) than the hand. Additionally, or alternatively, the created effector(s) may be created based upon data that is generated independently from data that is input to the node, such as a predetermined or randomly (or pseudo-randomly) generated value. For example, an effector could be created for the hand of a person, where this effector specifies a random displacement, in the virtual world, relative to the current location of the hand (e.g. to simulate the hand trembling). Additionally, or alternatively, the created effector(s) may be created based on input data from an operator/user during runtime, i.e. when the animation is being performed/executed (e.g. a game player)—for example, if the player of a game presses a button on a game controller to cause a game character to point a gun at a target, then the node could generate an effector for a hand of the game character that specifies a target location to which the hand should be moved (in order to simulate pointing the hand carrying the gun at the target). It will be appreciated that the effector(s) may be created based on a combination of these different types of data, for example, returning to the example of the skateboard and the person illustrated in FIG. 3, the node may receive, as an input, geometric data concerning the surface of the skateboard and effector data concerning the location of the person's ankle joint and may use this information to create an effector specifying a target/desired position for the ankle joint of the person to ensure that the sole of the person's foot coincides and aligns with the surface of the skateboard. The output for the respective operation includes effector data which represents the created effector.

The respective operation for some nodes 2620, 2630, 2660, 2670 and 2680 may be based upon effector data that is received as input to the node:

(b) The respective operation may involve modifying one or more of the effectors that are represented by the received/input effector data. The modification may be made without reference to any other effector(s) or non-effector data. As an example, the respective operation might add a minor random component to the position specified as an effector for a joint of the animation so as to create a shivering or shaking motion for the animation. The modification may be made with reference to the other effector(s) or non-effector data. As an example, the operation might ensure that the distance between two hands of a person in the animation never exceeds a particular limit. The operation may therefore refer to effector(s) which specify a target position for each hand and modify one of the effectors to ensure that this limit distance between the two hands is not exceeded.

(c) The respective operation may involve combining two (or more) effectors that are represented by the effector data. As an example, the input to the node might contain two (or more) effectors which are incompatible with each other. This could, for example, be the case where two effectors apply to the same joint but specify different positions or orientations for that joint. The operation might combine these two (or more) incompatible effectors into a single effector by averaging the values of the two (or more) different effectors. The average could be weighted based on the significance of each of the effectors to the animation such that the combined effector is closer to the more significant effector than the less significant effector.

(d) The respective operation may involve cancelling (or removing or destroying) at least one effector that was provided as input to the node. This means that the output from the node will not include effector data representing the cancelled effector. As an example, the effector data that is input to the node might represent two (or more) different effectors which are incompatible. This could, for example, be the case where the effectors represented by the effector data include two (or more) effectors which specify different positions or orientations for the same joint. Alternatively, this could, for example, be the case where effectors are defined for different joints which are incompatible with the animation. As an alternative example, the respective operation could operate to limit the number of effectors that are to be considered to a particular number. Therefore, the respective operation may cancel a number of effectors such that only the particular number of effectors are represented by effector data output from the node. The respective operation may therefore cancel one (or more) effectors. The respective operation may determine Which effector(s) should be cancelled by referring to a weighting which may be associated with the effectors to determine which of the effectors are more important to the animation. The respective operation may then cancel the less important effectors.

(e) The respective operation may involve solving inverse kinematics based on at least one of the effectors that is represented by the effector data that is input into the node. Any appropriate method for solving inverse kinematics may be used, as described above and as is known to the skilled person. As discussed above, solving the inverse kinematics for one of more effectors produces a set of joint angles which satisfy (or attempt to satisfy) the constraints set out by those effectors (where a solution is possible). Forward kinematics may then be performed based on the determined joint angles to derive geometric data for the animation. The derived joint angles and/or geometric data may be used to directly update the display of the animation. Alternatively (or additionally), a representation of the derived joint angles and/or geometric may be included in the non-effector output data for the node (which could, then, be processed by a subsequent node in the graph). The respective operation may act to solve all or only a subset of the effectors that are represented by the effector data that is input to the node. The effector(s) that have been solved by the respective operation may be excluded from the output to the node, such that they are not represented by effector data that is output from the node. Where the inverse kinematics has been solved for all effectors that are represented by the input effector data, the node may not therefore output any effector data at all. However, this need not be the case and the output for the node may include effector data representing effectors that have been solved using inverse kinematics and/or effector data representing effector(s) that have not been solved using inverse kinematics. Where this is the case, the output data may include an indication indicating the effectors for which inverse kinematics has already been solved, although again this is not necessary.

(f) The respective operation may involve solving inverse dynamics based on at least one of the effectors by passing the one or more effectors to a physics engine to derive a result for the one or more effectors. In a similar manner to the solving of inverse kinematics discussed in paragraph (e) above, the solving of inverse dynamics for the one or more effectors using the physics engine may result in geometric data which may be included in the output from the node, or may be used to update the display of the animation directly.

Whilst for the purposes of clarity the different functions that might be performed by each node 2610, 2620, 2630, 2640, 2650, 2660, 2670 and 2680 with respect to effectors has been discussed separately in paragraphs (a)-(f), it will be appreciated that the respective operation for a node 2610, 2620, 2630, 2640, 2650, 2660, 2670 and 2680 may include any combination of the above-mentioned functions. For example, a node may create one or more new effectors and cancel one or more effectors that are represented by effector data that is input to the node 2610, 2620, 2630, 2640, 2650, 2660, 2670 and 2680. It will, of course, be appreciated that different operations involving effector data (as an input to and/or as output from a node) may be performed, and embodiments of the invention are not limited to the examples given above.

A node that outputs an effector (i.e. outputs effector data representing the effector) may be referred to as an “effector source” node. An “effector source” node may create a new effector based on non-effector data and/or effector data received as an input to the effector source node. For example, FIG. 19 illustrates a graph comprising two “animation source” nodes (AnimSource1 and AnimSource2) that output respective data that define respective poses for the object 200 at a given point time; in a similar manner, a graph may comprise one or more “effector source” nodes that output respective effector data that define, respectively, one or more effectors for the object 200 at a given point time. An “effector source” node may, for example, create effector data representing one or more effectors by processing (i.e. based one) transform data and/or event data and/or time data and/or other data (e.g. data representing an input from a player of a computer game in which the animation is being performed). An “effector source” node may output non-effector data in addition to outputting effector data.

Similarly, a node that processes effector data may be referred to as an “effector consumer” node. An “effector consumer” node may receive effector data as an input to that node and process the effector data to generate and output effector data (that represents modified versions of the effector(s) represented by the input effector data and/or new effector(s)) and/or non-effector data (such as transform data for the object 200). For example, FIG. 19 illustrates a graph comprising a “blend node” that represents an operation that interpolates between two sets of transform data; in a similar manner, a graph may comprise an “effector consumer” node that represents a “blend” operation that interpolates between two or more sets of effector data that represent multiple effectors for the same part of the object 200 (for example, interpolating between first input effector data representing a first effector for a hand of a game character and second input effector data representing a second effector for the hand of the game character to generate output effector data representing third effector for the hand of the game character). The interpolation could be solely based on effector data received at the “effector consumer” node. Alternatively, the interpolation may be based on such input effector data along with additional data too, such as: transform data received from one or more animation source nodes; and/or the value of one or more weight control parameters (which may be predetermined and/or received as input data at the “effector consumer” node); and/or event data; and/or time data.

As an example, a graph may comprise (a) an effector source node that outputs effector data representing one or more effectors which represent targets for parts of a “person” object to cause the “person” object to walk; (b) an animation source node that outputs transform data representing the “person” object running; and (c) a blend node that receives the effector data and the transform data output by the effector source node and animation source node respectively along with event data output by these two nodes represents the respective timing of when a footfall occurs during the walking or running, and a weight control parameter. The blend node may then process the effector data and the transform data from the two source nodes, based on the event data and the weight control parameter, to produce output data to be output from the blend node. The output data may be output as effector data (i.e. the blend node could be considered to be an effector source node for another node in the graph)—for example, the effector data may represent an effector for a foot of the “person” object, where this effector is derived from input effector data that represents an effector for the foot and input transform data from which a position and/or orientation of the foot is derivable. The output data may be output as transform data—for example, the transform data may represent a position and/or orientation for a foot of the “person” object, where this position and/or orientation is derived from input effector data that represents an effector for the foot and input transform data from which a position and/or orientation of the foot is derivable. The output data may be output as both effector data and transform data. The output data may then represent a desired pose of the “person” object jogging. The generation of the output data may be based on the event data input to the blend node, with the event data being used to ensure that artefacts are not generated when creating the jogging animation from the running and walking data (as is known in the art). The weight control parameter controls how the output data is generated, e.g. how much the effector data for the “walking” and how much the transform data for the “running” contribute to the final output data, so that different speeds of “jogging” can be generated/simulated.

As another example, a graph may comprise (a) a first effector source node that outputs effector data representing one or more effectors which represent targets for parts of a “person” object to cause the “person” to move a hand towards a first particular location, such as pointing the hand in a certain direction; (b) a second effector source node that outputs effector data representing one or more effectors which represent targets for parts of the “person” object to cause the “person” to move the hand towards a second particular location, such as touching another part of the body of the “person” object; and (c) a blend node that receives the effector data output by the effector source nodes along with a weight control parameter. The blend node may then process the effector data from the two effector source nodes to produce output effector data. The output effector data represents one or more effectors which represent targets for parts of the “person” object to cause the “person” move the hand towards a third particular location—the third particular location may be calculated by the blend node as an interpolation between the first and second particular locations, with the interpolation being biased or weighted according to the weight control parameter; the third particular location may be selected by the blend node to be the first particular location or the second particular location, where the selection is based on the weight control parameter; the third particular location may be generated by other means.

It will be appreciated that each node in a graph may, respectively, be an “effector source” node, or an “effector consumer” node, or both an “effector source” node and an “effector consumer” node, or neither of an “effector source” node and an “effector consumer” node.

As illustrated in FIG. 26, the connections between nodes may be arranged in a variety of ways to form the graph 2600.

The input to a node 2620, 2630, 2660 and 2670 may include both effector data and non-effector data. However, the input to a node 2680 may include only effector data instead. Alternatively, the input to a node 2610, 2640 and 2650 might only include non-effector data.

The input data for a node 2610, 2640, 2650 and 2680 might be received from just one other node. Alternatively, the input data for a node 2620, 2630, 2660 and 2670 might be received from more than one other node.

The output from a node 2610, 2620, 2630 and 2660 may include both effector data and non-effector data. However, the output from a node 2650 and 2680 may only include effector data instead. Alternatively, the output from a node 2640 and 2670 might only include non-effector data.

The output data for a node 2610, 2630, 2660, 2670 and 2680 might be provided as input data for just one other node. Alternatively, the output data for a node 2620, 2640 and 2650 might be provided as input data for more than one other node.

It will be appreciated that although a specific structure of graph 2600 has been illustrated in FIG. 26, any other structures of graphs may be formed using the combinations of nodes and connections discussed above.

In general, therefore, the graph contains at least one connection between two nodes which represents that effector data output by a first node is input to the other node, whereby the effector data represents one or more effectors for the object 200. The graph therefore includes a flow of effector data between different nodes in the graph, allowing the nodes to perform operations based on effectors represented by the effector data. This means that it is not necessary to perform inverse kinematics (or inverse dynamics) to produce an output for each node, and instead allows the effectors themselves to be processed by different nodes in the graph before inverse kinematics (or inverse dynamics) is performed. This means that the frequency at which inverse kinematics (or inverse dynamics) needs to be performed is reduced as the inverse kinematics (or inverse dynamics) can be deferred within the graph. Furthermore, the operations performed by a node can process the effectors received from other nodes in the graph, effectors can be created, modified, merged, cancelled, etc. by other nodes in the graph prior to their evaluation by inverse kinematics (or inverse dynamics). This avoids unnecessary computation when evaluating inverse kinematics (or inverse dynamics) because evaluation is not performed for effectors which might exist in the graph, but which are ultimately not needed. This might be the case, for example, where an effector is cancelled by a subsequent node due to an incompatibility with another effector in the graph. This also provides the designer of the graph with a finer or more flexible control over how the animation is defined and processed, because individual effectors can be manipulated more easily so as to achieve a desired effect.

The graph also allows for existing animation graphs to be adapted to include a flow of effector data, since non-effector data flow is also allowed within the graph.

It will be appreciated that whilst FIGS. 7-24 have been described above primarily with reference to non-effector data, these figures, and their associated descriptions, apply equally to effector data—i.e. one or more of the connections between nodes in FIGS. 7-24 (as described with respect to those figures) may represent the passage of effector data in addition to, or as an alternative to, non-effector data from a first node to a second node in the graph. Examples of this have already been provided above with reference to FIG. 19. Such a passage of effector data between two nodes may be represented via a same connection that represents the passage of non-effector data between those two nodes; alternatively, a passage of effector data may be represented by a first connection between two nodes and the passage of non-effector data between those two nodes may be represented by one or more other connections between those two nodes. This applies equally to the “functional connections” described above so that, for example, graphs that include connections representing a flow of effector data between at least some of the nodes of the graph may include functional connections, where at least some of the data flow represented by the functional connection is effector data.

Similarly, the graph of FIG. 20, which shows how the graph of FIG. 19 might look after the functional inputs and outputs of FIG. 19 are expanded to expose their underlying components, can also be used together with “effector source” nodes as well as with “effector consumer” nodes. The graph of FIG. 20 uses functional connections in order to represent passing time data in the right-to-left direction, with other data, such as transform data and/or effector data (not shown in FIG. 20) being passed in the left-to-right direction.

The processor 108 may execute the compilation and dependencies represented by the graph of FIGS. 19 and 20 containing effector source nodes and/or effector consumer nodes in a similar manner to that described above without effector source nodes and effector consumer nodes. In such cases, the generation of the effectors by the “effector source” nodes and/or the processing of effectors by “effector consumer” nodes may depend upon time data being passed in the right-to-left direction by one of the aforementioned functional connections. An “effector source” node and/or an “effector consumer” node may be dependent on the output of other nodes in the graph—for example, an “effector source” node may be arranged to output effector data comprising an effector for a foot of a “person” object when another node in the graph outputs event data (which is ultimately received by the “effector source” node) indicating a footfall event for the “person” object. This “effector source” node may also be dependent on a node that outputs transform data relating to the current position of the foot of the “person object”, so that the “effector source” node can calculate what “target” location the effector for the foot should be represent (based on the current location of the foot). Similarly, one or more nodes in the graph may themselves be dependent on the output of an “effector source” node and/or an “effector consumer” node (e.g. effector data output by the “effector source” node and/or the “effector consumer” node)—for example, an inverse kinematics node that determines joint angles for the object 200 may receive, as part of its input, effector data and will, therefore, be dependent on an “effector source” node. These dependencies can be resolved in the same manner as discussed above with reference to FIGS. 19 and 20.

To further illustrate the animation graphs according to the present invention, the following examples are provided:

In one exemplary animation graph according to the present invention, a node might create ankle effectors to align the foot of a person to the terrain of the virtual world. Effectors are thus created according to the environment. Another node might use the current hand position (from an input animation) and set an effector to wave. The interesting point is that rather than solve for these effectors, the output of the previous nodes can be combined. Thus the ankle and hand effectors can be used by another node that will set an effector for the hip. The hip effector can be set by selecting the hip position from a set of input poses (animation data).

In another exemplary animation graph according to the present invention, a node might use the input animation data to determine the positions of the eyes and thus locate the viewing direction of the character. The node can then use this direction to determine an effector that will set the wrist and will make a gun aim at the same point. The node will not define just the effector to achieve the tasks, but it also considers the current position of the hand and it will clamp (limit) the possible positions such that they do not move more than a given distance per frame and make the motion of the hand realistic.

In a further exemplary animation graph according to the present invention, the input to the graph might be animation data of a hand hitting a fixed point (for a fighting animation, for example). As the animation is played, the effector is set as a weighted position between the current position of the hand in the animation and the position of a selected target. Another node in the graph uses this effector to look into a database of example animation poses for the animation that has the hand closer to the input effector position. The position and orientation of the elbow in the selected example pose defines the elbow effector.

In a final exemplary animation graph according to the present invention, a first node in the graph might create effectors for the ankles and knees of a person to provide a walking animation, whilst a subsequent node in the graph might modify the effectors to constrain the motion by reducing the knee angles by half, thereby making the animation of a person who appears to be injured.

It will be appreciated that embodiments of the invention may be implemented using a variety of different information processing systems. In particular, although FIG. 1 and the discussion thereof provide an exemplary computing architecture and computer, this is presented merely to provide a useful reference in discussing various aspects of the invention. Of course, the description of the architecture has been simplified for purposes of discussion, and it is just one of many different types of architecture that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

As described above, the system 100 comprises a computer 102. The computer 102 may be a dedicated games console specifically manufactured for executing computer games, a personal computer system, a mainframe, a minicomputer, a server, a workstation, a notepad, a personal digital assistant, or a mobile telephone, or, indeed, any other computing platform suitable for executing embodiments of the invention.

It will be appreciated that, insofar as embodiments of the invention are implemented by a computer program, then a storage medium and a transmission medium carrying the computer program form aspects of the invention. The computer program may have one or more program instructions, or program code, which, when executed by a computer carries out an embodiment of the invention. The term “program,” as used herein, may be a sequence of instructions designed for execution on a computer system, and may include a subroutine, a function, a procedure, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method of defining an animation of a virtual object within a virtual world, wherein the animation comprises performing, at each of a series of time points, an update that updates values for object attributes of the virtual object, the method comprising:
allowing a user to define the animation by specifying, on a user interface, a structure representing the animation, wherein the structure comprises a plurality of items and one or more connections between respective items, wherein each item represents a respective operation that may be performed when performing the update, wherein a connection between two items represents that respective output data generated by the operation represented by a first one of the two items is input to the operation represented by the other of the two items, and wherein for at least one of the one or more connections the respective data comprises effector data, the effector data representing one or more effectors for the virtual object.

2. The method of claim 1, wherein said allowing comprises allowing the user to specify that the structure comprises an item for which the respective operation comprises creating at least one effector for the virtual object and for which the output data generated by the respective operation comprises effector data representing the at least one created effector.

3. The method of claim 1, wherein said allowing comprises allowing the user to specify that the structure comprises a particular item for which:
(a) the input to the respective operation for said particular item comprises effector data representing one or more effectors for the virtual object; and
(b) the respective operation for said particular item generates output data based, at least in part, on at least one effector represented by the effector data of the input to the respective operation for said particular item.

4. The method of claim 3, wherein the respective output data generated by the respective operation for said particular item comprises effector data representing one or more effectors for the virtual object.

5. The method of claim 3, wherein said allowing comprises allowing the user to specify that the effector data of the respective output data generated by the respective operation for said particular item forms at least part of the respective data of the input to two or more other items of said structure.

6. The method of claim 3, wherein the respective operation for said particular item comprises modifying at least one effector that is represented by the effector data of the input to said respective operation for said particular item.

7. The method of claim 3, wherein the respective operation for said particular item comprises combining two or more effectors that are represented by the effector data of the input to said respective operation for said particular item.

8. The method of claim 3, wherein the respective operation for said particular item comprises cancelling at least one effector that is represented by the effector data of the input to said respective operation for said particular item.

9. The method of claim 3, wherein the respective operation for said particular item comprises performing inverse kinematics processing or inverse dynamics processing for the virtual object based on at least one effector that is represented by the effector data of the input to the respective operation for said particular item.

10. The method of claim 3, wherein said allowing comprises allowing the user to specify that the effector data of the input to the respective operation for said particular item comprises first effector data of the respective output data generated by the respective operation of a first item of said structure and second effector data of the respective output data generated by the respective operation of a second item of said structure.

11. A method of animating a virtual object within a virtual world, wherein the animation comprises performing, at each of a series of time points, an update that updates values for object attributes of the virtual object, the method comprising performing processing based on a user-defined structure representing the animation, the user-defined structure comprising a plurality of items and one or more connections between respective items, wherein each item represents a respective operation that may be performed when performing the update, wherein a connection between two items represents that respective output data generated by the operation represented by a first one of the two items is input to the operation represented by the other of the two items, wherein for at least one of the one or more connections the respective data comprises effector data, the effector data representing one or more effectors for the virtual object.

12. The method of claim 11, wherein the structure comprises an item for which the respective operation comprises creating at least one effector for the virtual object and for which the output data generated by the respective operation comprises effector data representing the at least one created effector.

13. The method of claim 11, wherein the structure comprises a particular item for which:
(a) the input to the respective operation for said particular item comprises effector data representing one or more effectors for the virtual object; and
(b) the respective operation for said particular item generates output data based, at least in part, on at least one effector represented by the effector data of the input to the respective operation for said particular item.

14. The method of claim 13, wherein the respective output data generated by the respective operation for said particular item comprises effector data representing one or more effectors for the virtual object.

15. The method of claim 13, wherein the effector data of the respective output data generated by the respective operation for said particular item forms at least part of the respective data of the input to two or more other items of said structure.

16. The method of claim 13, wherein the respective operation for said particular item comprises modifying at least one effector that is represented by the effector data of the input to said respective operation for said particular item.

17. The method of claim 13, wherein the respective operation for said particular item comprises combining two or more effectors that are represented by the effector data of the input to said respective operation for said particular item.

18. The method of claim 13, wherein the respective operation for said particular item comprises cancelling at least one effector that is represented by the effector data of the input to said respective operation for said particular item.

19. The method of claim 13, wherein the respective operation for said particular item comprises performing inverse kinematics processing or inverse dynamics processing for the virtual object based on at least one effector that is represented by the effector data of the input to the respective operation for said particular item.

20. The method of claim 13, wherein the effector data of the input to the respective operation for said particular item comprises first effector data of the respective output data generated by the respective operation of a first item of said structure and second effector data of the respective output data generated by the respective operation of a second item of said structure.

21. The method of claim 13, wherein each of said one or more effectors for the virtual object comprises, respectively, one or more of: a target for at least part of said virtual object; and a constraint for at least part of said virtual object.

22. The method of claim 13, wherein the structure is a graph.

23. The method of claim 22, wherein the graph is a directed acyclic graph.

24-26. (canceled)

27. A system comprising:
one or more processors; and
a memory storing executable instructions that, when executed by the one or more processors, cause the one or more processors to perform operations comprising:
allowing a user to define the animation by specifying, on a user interface, a structure representing the animation, wherein the structure comprises a plurality of items and one or more connections between respective items, wherein each item represents a respective operation that may be performed when performing the update, wherein a connection between two items represents that respective output data generated by the operation represented by a first one of the two items is input to the operation represented by the other of the two items, and wherein for at least one of the one or more connections the respective data comprises effector data, the effector data representing one or more effectors for the virtual object.
